(19) United States
(12) Patent Application Publication
(10) Pub. No.: US 2026/0149625 A1
(43) Pub. Date: May 28, 2026

(54) COMMUNICATION METHOD AND COMMUNICATION APPARATUS

(71) Applicant: Huawei Technologies Co., Ltd., Shenzhen (CN)

(72) Inventors: Xiaoyan Bi, Shanghai (CN); Jianglei Ma, Ottawa (CA); Yiqun Ge, Ottawa (CA); Wuxian Shi, Ottawa (CA)

(21) Appl. No.: 19/409,534

(22) Filed: Dec. 4, 2025

Related U.S. Application Data
(63) Continuation of application No. PCT/CN2023/117568, filed on Sep. 7, 2023.
(60) Provisional application No. 63/506,719, filed on Jun. 7, 2023.

(51) Int. Cl. H04L 25/02; H04L 27/26

(52) U.S. Cl. CPC H04L 25/0202; H04L 27/261

(57) ABSTRACT

Embodiments of the present application provide a communication method and a communication apparatus. The method includes: a communication apparatus performs a first channel estimation to obtain first channel information of a first channel and second channel information of a second channel, and obtains assistance information based on the first channel information and the second channel information, where the assistance information indicates a relationship between the first channel and the second channel. The method could be viewed as a training procedure to obtain the assistance information, and the assistance information is for further channel estimation.

### CROSS-REFERENCE TO RELATED APPLICATIONS

This application is a continuation of International Application No. PCT/CN2023/117568, filed on Sep. 7, 2023, which claims priority to US provisional Patent Application No. 63,506,719, filed on Jun. 7, 2023. The disclosures of the aforementioned applications are hereby incorporated by reference in their entireties.

### TECHNICAL FIELD

Embodiments of the present application relate to the field of communications, and more specifically, to a communication method and a communication apparatus.

### BACKGROUND

In a wireless communication system, to implement functions such as system synchronization, channel information feedback, and data transmission, channel estimation needs to be performed on an uplink channel or a downlink channel.

For performing the channel estimation, reference signals could be transmitted between a receiving apparatus and a transmitting apparatus. How the reference signals are used to perform the channel estimation is an urgent problem to be solved.

### SUMMARY

Embodiments of the present application provide a communication method and a communication apparatus. The technical solutions may improve channel estimation performance.

According to a first aspect, an embodiment of the present application provides a communication method, and the method could be performed by a communication apparatus. The communication apparatus is a communication device (for example, a base station or a user equipment (UE)) or a chip in the communication device. The method includes: performing a first channel estimation to obtain first channel information of a first channel and second channel information of a second channel; and obtaining assistance information based on the first channel information and the second channel information, where the assistance information indicates a relationship between the first channel and the second channel.

According to the above technical solution, a communication apparatus could obtain channel measurements as training data, that is the first channel information and the second channel information, then the communication apparatus could obtain the assistance information based on the training data (first channel information and the second channel information). The assistance information indicates a relationship between the first channel and the second channel, therefore the assistance information could be used for channel estimation which could improve channel estimation performance. For example, the communication apparatus could obtain coefficients of one channel based on coefficients of the other channel and the assistance information.

In a possible design, the performing a first channel estimation to obtain first channel information of a first channel and second channel information of a second channel includes: performing the first channel estimation in different time ranges and/or different frequency ranges to obtain the first channel information and the second channel information.

According to the above technical solution, reference signals which is used for the first channel estimation to obtain the first channel information and the second channel information could be obtained in different time ranges and/or different frequency ranges, which may improve accuracy of the assistance information.

In a possible design, the obtaining assistance information based on the first channel information and the second channel information includes: obtaining the assistance information based on the first channel information and the second channel information by one or more of the following: artificial intelligence, manifold, or subspace projection.

In a possible design, the method further includes: receiving first reference signals; and performing a second channel estimation based on the first reference signals and the assistance information.

According to the above technical solution, after obtaining the assistance information, the communication apparatus could perform channel estimation based on the assistance information.

In a possible design, the assistance information includes a pattern of the first reference signals, and the method further includes: transmitting the pattern of the first reference signals.

In a possible design, the pattern of the first reference signals indicates one or more locations of the first reference signals, and the one or more locations include one or more frequency domain locations, where the one or more frequency domain locations are related to one or more transmit ports or code division multiplexing groups.

In a possible design, the method further includes: transmitting the assistance information and second reference signals; and receiving channel matrix information or channel state information, where the channel matrix information or the channel state information is determined by estimating a channel based on the assistance information and the second reference signals.

According to the above technical solution, after obtaining the assistance information, the communication apparatus could transmit the assistance information to other communication apparatus, then the other communication apparatus could perform channel estimation based on the assistance information.

In a possible design, the method further includes: determining the channel state information based on the channel matrix information and the assistance information.

In a possible design, the assistance information includes a pattern of the second reference signals.

In a possible design, the assistance information includes one or more of the following: a first matrix, a second matrix, and a permutation matrix, where the first matrix and the second matrix represent a channel space basis matrix, and a dimension of the first matrix is larger than a dimension of the second matrix.

According to a second aspect, an embodiment of the present application provides a communication method, and the method could be performed by a communication apparatus. The communication apparatus is a communication device (for example, a base station or a UE) or a chip in the communication device. The method includes: receiving reference signals; and performing a second channel estimation based on the reference signals and assistance information, where the assistance information is determined based on first channel information of a first channel and second channel information of a second channel, the first channel information and the second channel information is determined by performing first channel estimation, where the assistance information indicates a relationship between the first channel and the second channel.

According to the above technical solution, the assistance information indicates a relationship between different channels (e.g. the first channel and the second channel), and therefore a communication apparatus could perform channel estimation based on received reference signals to obtain channel coefficients corresponding to one channel, and obtain second channel coefficients corresponding to another channel based on the channel coefficients and the assistance information. This could improve channel estimation accuracy, and, as a transmitting apparatus does not need transmit reference signals corresponding to another channel, could save signaling overhead.

In a possible design, the first channel information and second channel information are determined by performing the first channel estimation in different time ranges and/or different frequency ranges.

In a possible design, the assistance information is determined based on first channel information and second channel information by using one or more of the following: artificial intelligence, manifold, or subspace projection

In a possible design, the method further includes: receiving the assistance information.

In a possible design, the assistance information includes a pattern of the reference signals.

In a possible design, the pattern of the reference signals indicates one or more locations of the reference signals, and the one or more locations of the reference signals include frequency domain locations, where the frequency domain locations are related to one or more transmit ports or code division multiplexing groups.

In a possible design, the performing a second channel estimation based on the reference signals and assistance information includes: performing the second channel estimation based on the reference signals and the assistance information to obtain channel matrix information or channel state information; and transmitting the channel matrix information or the channel state information.

In a possible design, the assistance information includes one or more of the following: a first matrix, a second matrix, and a permutation matrix, the first matrix and the second matrix represent a channel space basis matrix, and a dimension of the first matrix is larger than a dimension of the second matrix.

Various implementations of the second aspect correspond to various implementations of the first aspect. For the various implementations and the beneficial technical effects of the various implementations of the second aspect, reference may be made to the descriptions of the relevant implementations of the first aspect, which will not be repeated here.

According to a third aspect, a communication apparatus is provided, and configured to perform the method in any possible implementation of the foregoing aspects. Specifically, the apparatus includes a unit configured to perform the method in any possible implementation of the foregoing aspects.

According to a fourth aspect, another communication apparatus is provided, including a processor. The processor is coupled to a memory, and may be configured to execute one or more instructions in the memory, to implement the method in any possible implementation of the various aspects. The memory may be an on-chip storage unit inside the processor, or may be an off-chip storage unit that is coupled to the memory and located outside the processor. In a possible implementation, the apparatus further includes the memory. In a possible implementation, the apparatus further includes a communication interface, and the processor is coupled to the communication interface.

In a possible design, the communication apparatus may be a transmitting apparatus (for example, a base station or a user equipment), may be a chip, a circuit, or a processing system configured in the transmitting apparatus, or may be a device including the transmitting apparatus.

In a possible design, the communication apparatus may be a receiving apparatus (for example, a base station or a user equipment), may be a chip, a circuit, or a processing system configured in the receiving apparatus, or may be a device including the receiving apparatus.

According to a fifth aspect, a computer-readable storage medium is provided. The computer-readable storage medium stores a computer program, and when the computer program is executed by a communication apparatus, the communication apparatus is enabled to implement the method in any possible implementation of the foregoing aspects.

According to a sixth aspect, a computer program product including one or more instructions is provided. When the instructions are executed by a computer, a communication apparatus is enabled to implement the method in any possible implementation of the foregoing aspects.

### DESCRIPTION OF THE DRAWINGS

FIG. 1 is a schematic diagram of an application scenario according to this application;

FIG. 2 illustrates an example communication system 100;

FIG. 3 illustrates another example of an electronic device (ED) 110 and a base station 170a, 170b and/or 170c;

FIG. 4 is an example of a channel model of a multiple-input multiple-output (MIMO) system;

FIG. 5 is a schematic flowchart of a communication method 500 according to an embodiment of this application;

FIG. 6 is a schematic interaction diagram of a communication method 600 applicable to an embodiment of this application;

FIG. 7 is a schematic interaction diagram of a communication method 700 applicable to another embodiment of this application;

FIG. 8 is an illustration of explicit channel feedback;

FIG. 9 is another illustration of explicit channel feedback;

FIG. 10 is a schematic interaction diagram of a communication method 1000 applicable to another embodiment of this application;

FIG. 11 is a schematic interaction diagram of a communication method 1100 applicable to another embodiment of this application;

FIG. 12 is a schematic interaction diagram of a communication method 1200 applicable to another embodiment of this application;

FIG. 13 is a schematic block diagram of a communication apparatus according to an embodiment of this application;

FIG. 14 is a schematic block diagram of another communication apparatus according to an embodiment of this application;

FIG. 15 illustrates the main procedure for the embodiment 1;

FIG. 16 is an illustration of channel parameters;

FIG. 17 is an illustration of feedback the channel information of indicated pairs of RX and RE location in frequency;

FIG. 18 is an illustration of feedback the channel information of a group of or all RXs in RE location in frequency;

FIG. 19 illustrates the main procedure for the embodiment 2;

FIG. 20 is an illustration of DL full channel;

FIG. 21 illustrates the main procedure for the embodiment 3;

FIG. 22 illustrates the main procedure for the embodiment 4;

FIG. 23 illustrates the main procedure for the embodiment 5; and

FIG. 24 illustrates units or modules in a device.

### DETAILED DESCRIPTION OF THE ILLUSTRATIVE EMBODIMENTS

The following describes technical solutions of the present application with reference to the accompanying drawings.

The technical solutions in embodiments of this application may be applied to multiple-input multiple-output (MIMO) technology. And the technical solutions in embodiments of this application may be applied to various communication systems, such as a fifth generation (5G) wireless communication system, a new ratio (NR) wireless communication system, a Long Term Evolution (LTE) system, an LTE frequency division duplex (FDD) system, an LTE time division duplex (TDD) system, a wireless local area network (WLAN), a satellite communication system, or other evolving communication systems, such as a sixth generation (6G) wireless communication system.

For ease of understanding of the embodiments of this application, a communication system shown in FIG. 1-FIG. 3 is used as an example to describe in detail a communication system to which the embodiments of this application are applicable.

Referring to FIG. 1, as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a-110j (generically referred to as ED 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the Internet 150, and other networks 160.

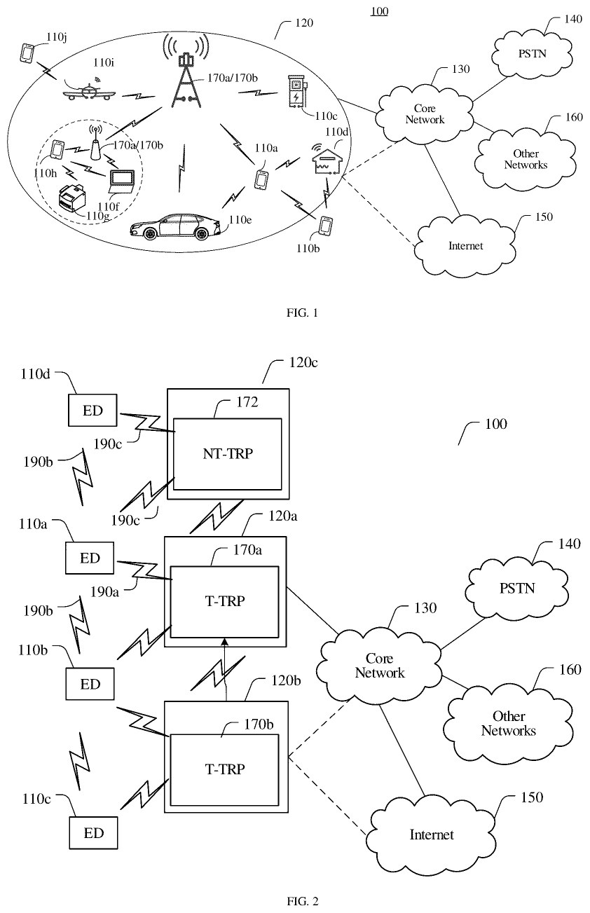

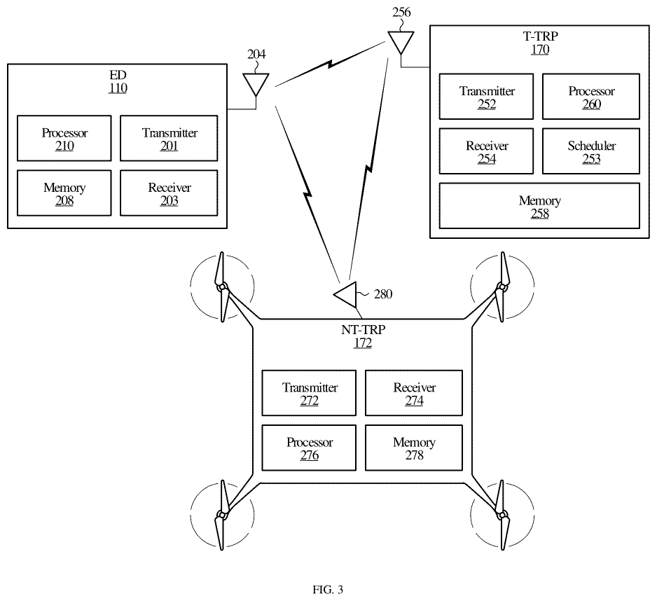

Referring to FIG. 2, an example communication system 100 is illustrated. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the Internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), and User Datagram Protocol (UDP). EDs 110a 110b, and 110c may be multimode devices capable of operation according to multiple radio access technologies, and incorporate multiple transceivers necessary to support such.

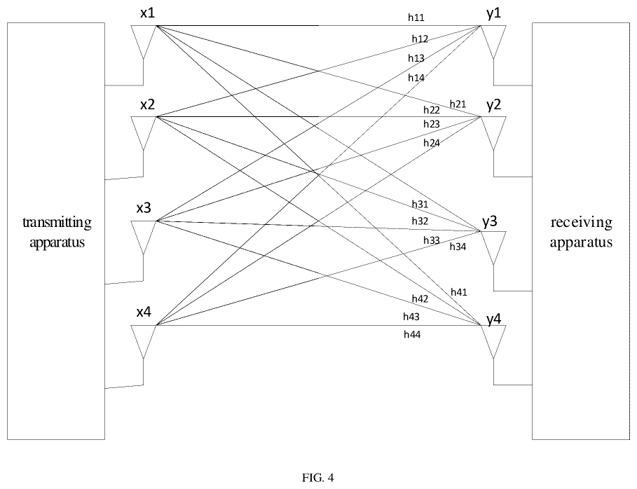

Referring to FIG. 3, another example of an ED 110 and a base station 170a, 170b and/or 170c is illustrated. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or an apparatus (e.g. a communication module, a modem, or a chip) in the forgoing devices, among other possibilities. Future generation EDs 110 may be referred to as other terms. The base station 170a and 170b is a T-TRP and will hereafter be referred to as T-TRP 170. Also, as shown in FIG. 3, an NT-TRP will hereafter be referred to as NT-TRP 172. Each ED 110 connected to T-TRP 170 and/or NT-TRP 172 can be dynamically or semi-statically turned on (i.e., established, activated, or enabled), turned off (i.e., released, deactivated, or disabled) and/or configured in response to one or more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmissions to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be reference signals transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations related to network access (e.g. initial access) and/or downlink synchronization, such as operations related to detecting a synchronization sequence, decoding and obtaining the system information, etc. In some embodiments, the processor 210 may perform channel estimation, e.g. using reference signals received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and the receiver 203 may each be implemented by the same or different one or more processors that are configured to execute instructions stored in a memory (e.g. in memory 208). Alternatively, some or all of the processor 210, and the processing components of the transmitter 201 and the receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. a communication module, a modem, or a chip) in the foregoing devices.

The CU (or CU-control plane (CP) and CU-user plane (UP)), DU or RU may be known by other names in some implementations. For example, in an open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remotely from the equipment housing the antennas of the T-TRP 170, and may be coupled to the equipment housing the antennas over a communication link (not shown) sometimes known as front haul, such as a common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations related to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by a scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

The scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and executed by the processor 260.

Although not illustrated, the processor 260 may form part of the transmitter 252 and/or the receiver 254. Also, although not illustrated, the processor 260 may implement the scheduler 253. Although not illustrated, the memory 258 may form part of the processor 260.

The processor 260, the scheduler 253, and the processing components of the transmitter 252 and the receiver 254 may each be implemented by the same or different one or more processors that are configured to execute instructions stored in a memory, e.g. in memory 258. Alternatively, some or all of the processor 260, the scheduler 253, and the processing components of the transmitter 252 and the receiver 254 may be implemented using dedicated circuitry, such as an FPGA, a GPU, or an ASIC.

The NT-TRP 172 is illustrated as a drone only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and the receiver 274 may each be implemented by the same or different one or more processors that are configured to execute instructions stored in a memory, e.g. in memory 278. Alternatively, some or all of the processor 276 and the processing components of the transmitter 272 and the receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

For ease of understanding of the embodiments of this application, the following briefly describes several terms used in this application.

### 1) Multiple-Input Multiple-Output (MIMO)

MIMO technology allows an antenna array of multiple antennas to perform signal transmissions and receptions to meet high transmission rate requirements. The above ED110 and T-TRP 170, and/or NT-TRP use MIMO to communicate over wireless resource blocks. MIMO utilizes multiple antennas at the transmitting apparatus and/or receiving apparatus to transmit the wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attention from the academia and the industry. In the large-scale MIMO system, the T-TRP 170 and/or NT-TRP 172 is generally configured with more than ten antenna units (such as 128 or 256), and serves for dozens of the EDs 110. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase in the number of antennas allows each antenna unit to be made smaller and at a lower cost. Using the degree of spatial freedom provided by the large-scale antenna units, the T-TRP 170 and NT-TRP 172 of each cell can communicate with many EDs 110 in the cell on the same time-frequency resource at the same time, thus greatly increasing the spectrum efficiency. A large number of antenna units of the T-TRP 170 and/or NT-TRP 172 also enable each user to have better spatial directivity for uplink and downlink transmission, so that the transmitting power of the T-TRP 170 and/or NT-TRP 172 and an ED 110 is reduced, and the power efficiency is greatly increased. When the number of antennas of the T-TRP 170 and/or NT-TRP 172 is sufficiently large, random channels between each ED 110 and the T-TRP 170 and/or NT-TRP 172 can be close to be orthogonal, and the interference between the cell and the users and the effect of noises can be eliminated. The plurality of advantages described above enable the large-scale MIMO to have a magnificent application prospect.

A MIMO system may include a receiving apparatus connected to a receive (Rx) antenna, a transmitting apparatus connected to a transmit (Tx) antenna, and a signal processor connected to the transmitting apparatus and the receiving apparatus. Each of the Rx antenna and the Tx antenna may include a plurality of antennas. For instance, the Rx antenna may have a ULA antenna array in which the plurality of antennas is arranged in a line at even intervals. When a radio frequency (RF) signal is transmitted through the Tx antenna, the Rx antenna may receive a signal reflected and returned from a forward target. The receiving apparatus could be an ED (i.e. ED 110) and the transmitting apparatus could be a T-TRP or NT-TRP (i.e. T-TRP 170 or NT-TRP 172), or the receiving apparatus could be a T-TRP or NT-TRP (i.e. T-TRP 170 or NT-TRP 172) and the transmitting apparatus could be an ED (i.e. ED 110).

Referring to FIG. 4, as an illustrative example without limitation, a simplified schematic illustration of a communication scenario is provided. A transmitting apparatus is connected to four Tx antennas, x1 to x4, a receiving apparatus is connected to four Rx antennas, y1 to y4, and a transmission channel may be formed between each Tx antenna and each Rx antenna. For example, an RF signal transmitted through x1 may be received by y2 through channel h21. The RF signal transmitted through x3 may be received by y1 through channel h13.

Hereafter, a base station is used as an example of T-TRP 170 or NT-TRP 172, and the UE is used as an example of ED 110. A receiving apparatus may be referred to as ED 110 for a downlink transmission, and T-TRP 170 or NT-TRP 172 for an uplink transmission. A transmitting apparatus may be referred to as T-TRP 170 or NT-TRP 172 for a downlink transmission, and ED 110 for an uplink transmission. However, limitation is not made herein.

### 2) Channel Estimation

In a MIMO system, to implement functions such as system synchronization, channel information feedback, and data transmission, channel estimation needs to be performed on an uplink channel or a downlink channel. Channel estimation refers to the process of reconstructing or restoring received signals to compensate for signal distortion caused by channel fading and noise. In channel estimation, reference signals predicted by a transmitting apparatus and a receiving apparatus may be used to track a change in the time domain and/or frequency domain of a channel, so as to reconstruct or restore a received signal. The reference signals may also be referred to as a pilot signal, a reference sequence or the like, and are described as reference signals in the following for ease of understanding. The reference signal includes, for example, a channel state information-reference signal (CSI-RS), a sounding reference signal (SRS), a demodulation reference signal (DMRS), a phase track reference signal (PT-RS), or a cell reference signal (CRS). The reference signals listed above are merely examples, and shall not constitute any limitation on this application. This application does not exclude the possibility that other reference signals are defined in a future protocol to implement the same or similar function.

In an implementation, a transmitting apparatus maps a sequence of reference signals to certain physical resources, and transmits the reference signals over the certain physical resources, where the sequence of reference signals and the physical resources are known to both the transmitting apparatus and the receiving apparatus receiving the reference signals. Thus, the receiving apparatus could perform channel estimation based on the received reference signals.

The process of transmitting reference signals described below may be performed by a base station, or may be performed by a UE. The process of measuring a channel may be performed by the UE when the base station transmits the reference signals, and may be performed by the base station when the UE transmits the reference signals. In the present application, an apparatus that transmits the reference signals is referred to as a transmitting apparatus and an apparatus that measures a channel based on the reference signals is referred to as a receiving apparatus.

### 3) Antenna Port

An antenna port, which may also be referred to as port for short, is a transmitting antenna identified by a receiver, or a transmitting antenna that can be distinguished in spatial domain. For each virtual antenna, one antenna port may be configured, and each virtual antenna may be a weighted combination of multiple physical antennas. Each antenna port may correspond to one reference signals port.

### 4) Quasi-Co-Location (QCL)

Two antenna ports are said to be quasi co-located if the large-scale properties (or channel features) of the channel over which a symbol on one antenna port is conveyed can be inferred from the channel over which a symbol on the other antenna port is conveyed.

The large-scale properties (or channel features) may include one or more of the following: delay spread, Doppler spread, Doppler shift, average delay, average gain, and Spatial RX parameter. The spatial RX parameter may include, for example, angle of arrival (AOA), average AOA, AOA spread, angle of departure (AOD), average AOD, AOD spread, and RX antenna spatial correlation parameter, Tx antenna spatial correlation parameter, transmit beam, receive beam, resource identifier, and the like.

The angle mentioned above may be decomposition values of different dimensions, or a combination of decomposition values of different dimensions. The two antenna ports mentioned above may be antenna ports with different antenna port numbers, and/or, antenna ports with a same antenna port number that send or receive information in different time and/or frequency and/or code domain resources, and/or, antenna ports that have different antenna port numbers to send or receive information in different time and/or frequency and/or code domain resources. The resource identifier may include, for example, a CSI-RS resource identifier, an SRS resource identifier, a synchronization signal/synchronization signal block resource identifier, a demodulation reference signal (DMRS) resource identifier, or resource identifier of preamble sequence transmitted on physical random access channel (PRACH).

### 5) Assistance Information

The assistance information indicates a relationship between different channels. Specifically, a receiving apparatus receives reference signals, and performs channel estimation based on the reference signals to obtain first channel coefficients corresponding to a first channel; and the receiving apparatus could obtain second channel coefficients corresponding to a second channel based on the first channel coefficients and assistance information, where the assistance information indicates a relationship between the first channel and the second channel. Based on the foregoing technical solution, the receiving apparatus could obtain the second channel coefficients based on the first channel coefficients and the assistance information, and thus a transmitting apparatus does not need transmit reference signals corresponding to the second channel to obtain the second channel coefficients.

The channel coefficients represent one or more values of a channel matrix. For example, the receiving apparatus performs channel estimation based on the reference signals, and determines a matrix of the first channel based on a channel estimation result, and values of the matrix of the first channel could be referred to as the first channel coefficients.

In some embodiments, the assistance information may comprise: matrix based information, vector based information, tensor based information, and manifold information.

As described above, the assistance information could be used for channel estimation. This application provides solutions on how to obtain the assistance information. Specifically, here are two phases, for the first phase, a communication apparatus (e.g. a UE, or, a base station) obtains assistance information through training; and for the second phase, the communication apparatus configures the assistance information for channel estimation.

The following describes the embodiments of this application in detail with reference to the accompanying drawings.

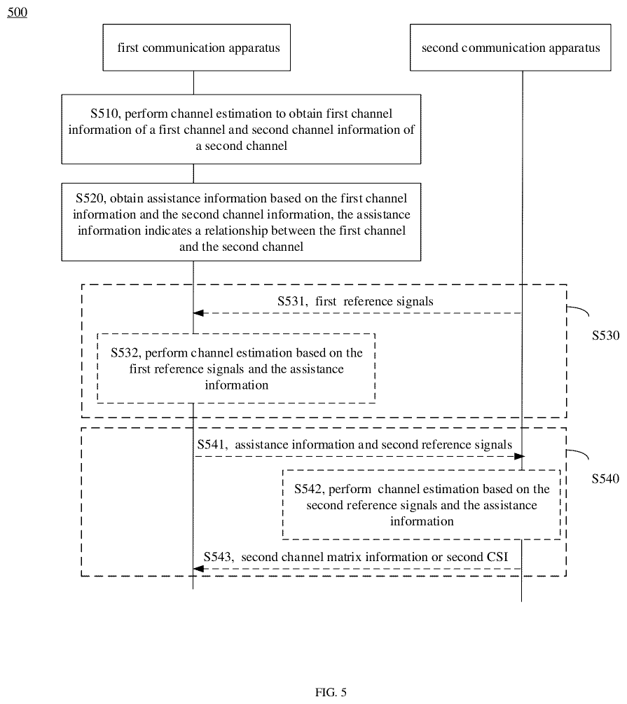

Referring to FIG. 5, a schematic flowchart of a communication method 500 according to an embodiment of this application is shown. The communication method 500 may be applied to the communication system 100 shown in FIG. 1.

At S510, a first communication apparatus performs channel estimation to obtain first channel information of a first channel and second channel information of a second channel.

The first communication apparatus is a communication device (for example, a base station or a UE) or a chip in the communication device.

The first channel and the second channel could be physical channels or precoding channels.

In a possible implementation, the first communication apparatus receives reference signals (reference signals #1), and performs channel estimation based on the reference signals #1 to obtain the first channel information; and the first communication apparatus receives reference signals (reference signals #2), and performs channel estimation based on the reference signals #2 to obtain the second channel information.

In some embodiments, the first communication apparatus performs channel estimation in different time ranges and/or different frequency ranges to obtain the first channel information and the second channel information. For example, the first communication apparatus receives reference signals #1 in different time ranges and/or different frequency ranges, and performs channel estimation based on the reference signals #1 to obtain the first channel information; and the first communication apparatus receives reference signals #2 in different time ranges and/or different frequency ranges, and performs channel estimation based on the reference signals #2 to obtain the second channel information.

The time ranges could be represented by one or more time domain units. A time domain unit may include, but is not limited to, a symbol, such as an orthogonal frequency division multiplexing (OFDM) symbol, a slot and a transmission time interval (TTI), etc.

The frequency ranges could be represented by one or more frequency domain units. A frequency domain unit may include, but is not limited to, a subcarrier, a subband, a resource block (RB), a resource block group (RBG), a bandwidth part (BWP), etc.

Further, the time ranges and/or frequency ranges could be different in different cases. For example, in some cases, the first communication apparatus performs channel estimation offline to obtain the first channel information and the second channel information, i.e., the first communication apparatus collects training data (the first channel information and the second channel information) and then the communication apparatus trains offline to obtain the assistance information, the time ranges could include hundreds of TTIs and the whole frequency band for transmission of reference signals #1 and reference signals #2. In other cases, the first communication apparatus performs channel estimation online to obtain the first channel information and the second channel information, i.e., the first communication apparatus collects training data (the first channel information and the second channel information) and then the communication apparatus trains online to obtain the assistance information, the time ranges could include several symbols and subcarriers or BWP for transmission of reference signals #1 and reference signals #2.

At S520, the first communication apparatus obtains assistance information based on the first channel information and the second channel information, and the assistance information indicates a relationship between the first channel and the second channel.

Based on the foregoing technical solution, a communication apparatus (e.g. the first communication apparatus) could obtain channel measurements as training data, that is the first channel information and the second channel information, then the communication apparatus could obtain the assistance information based on the training data (the first channel information and the second channel information). The assistance information indicates a relationship between the first channel and the second channel, and therefore the assistance information could be used for channel estimation. For example, the communication apparatus could obtain coefficients of one channel based on coefficients of the other channel and the assistance information.

In some embodiments, the first communication apparatus obtains the assistance information based on the first channel information and the second channel information by one or more of the following: artificial intelligence (AI), manifold, or subspace projection. As an example, the assistance information is obtained using AI where the first channel information and the second channel information could be inputted into an AI model, and the assistance information is an output of the AI model. For example, the AI model could be located in the first communication apparatus.

The assistance information could be obtained offline and/or online. For example, the first communication apparatus obtains initial assistance information based on the first channel information and the second channel information offline, and then the first communication apparatus updates the initial assistance information online.

In some embodiments, the method 500 further includes S530 or S540.

In a possible implementation, the method 500 further includes S530, where S530 includes S531 and S532.

At S531, the first communication apparatus receives first reference signals. Correspondingly, a second communication apparatus transmits the first reference signals.

The second communication apparatus in the following is a communication device (for example, a base station or a UE) or a chip in the communication device.

At S532, the first communication apparatus performs channel estimation based on the first reference signals and the assistance information.

Based on the foregoing technical solution, after obtaining the assistance information, the first communication apparatus could perform channel estimation based on the assistance information.

For example, the first communication apparatus performs channel estimation based on the first reference signals to obtain first channel coefficients corresponding to the first channel; and the first communication apparatus could obtain second channel coefficients corresponding to the second channel based on the first channel coefficients and the assistance information.

In some embodiments, the assistance information includes a pattern of the first reference signals, and the first communication apparatus transmits the pattern of the first reference signals. Correspondingly, the second communication apparatus receives the pattern of the first reference signals. A pattern of reference signals is defined as a series of locations where reference signals are transmitted to perform channel estimation. The pattern of the reference signals may also be referred to as a location of a resource of the reference signals. A location is generally composed of indication information from one or more of three dimensions of time, frequency and space. But not all conditions require indication information in three dimensions to be specified.

Based on the foregoing technical solution, the second communication apparatus could transmit the first reference signals based on the pattern of the first reference signals indicated by the first communication apparatus.

In some implementations, the pattern of the first reference signals indicates one or more locations of the first reference signals, and the one or more locations include one or more frequency domain locations. In a possible implementation, the one or more frequency domain locations are related to one or more transmit ports or code division multiplexing (CDM) groups.

For an example, the locations of the first reference signals include one or more pairs of Tx and RE locations in a frequency domain. For example, the locations of the first reference signals include two pairs: Tx antenna port #1 and RE #1, and, Tx antenna port #2 and RE #2. That means if the second communication apparatus transmits the first reference signals with the Tx antenna port #1, the second communication apparatus transmits the first reference signals on the RE #1, and if the second communication apparatus transmits the first reference signals with the Tx antenna port #2, the second communication apparatus transmits the first reference signals on the RE #2.

For another example, the locations of the first reference signals include one or more RE locations in a frequency domain. In this example, regardless of which antenna port may be used to transmit the first reference signals, the first reference signals are transmitted on the one or more REs.

For yet another example, the locations of the first reference signals include one or more pairs of CDM groups and RE locations in a frequency domain. For example, the locations of the first reference signals include two pairs: CDM group #1 and RE #1, and CDM group #2 and RE #2. That means if the second communication apparatus transmits the first reference signals with the CDM group #1, the second communication apparatus transmits the first reference signals on the RE #1, and if the second communication apparatus transmits the first reference signals with the CDM group #2, the second communication apparatus transmits the first reference signals on the RE #2.

Further, in some embodiments, the first communication apparatus obtains first channel matrix information or first channel state information (CSI) based on the channel estimation result, and the first communication apparatus transmits the first channel matrix information or the first CSI.

Channel matrix information (e.g. the first channel matrix information) or CSI (e.g. the first CSI) is used to reconstruct (or construct) or precode a channel. For example, the CSI may include one or more of: a channel quality indicator (CQI), a precoding matrix indicator (PMI), and a layer indicator (LI). For example, the channel matrix information includes one or more of: channel matrix, and one or more channel parameters corresponding to the channel matrix.

The “first channel matrix information” and the “first CSI” are only named for differentiation and do not limit the scope of protection of the embodiments of this application. Similarly, “second channel matrix information” and “second CSI” in the following description are also only named for differentiation and do not limit the scope of protection of the embodiments of this application, and this will not be repeated below.

In another possible implementation, the method 500 further includes S540, where S540 includes S541, S542 and S543.

At S541, the first communication apparatus transmits the assistance information and second reference signals. Correspondingly, the second communication apparatus receives the second reference signals and the assistance information.

At S542, the second communication apparatus performs channel estimation based on the second reference signals and the assistance information.

Further, the second communication apparatus obtains second channel matrix information or second CSI based on the channel estimation result.

At S543, the second communication apparatus transmits the second channel matrix information or the second CSI. Correspondingly, the first communication apparatus receives second channel matrix information or second CSI.

Based on the foregoing technical solution, after obtaining the assistance information, the first communication apparatus could transmit the assistance information to the second communication apparatus, then the second communication apparatus could perform channel estimation based on the assistance information.

Further, in some embodiments, based on S543, if the first communication apparatus receives the second channel matrix information, then the first communication apparatus determines the second CSI based on the second channel matrix information and the assistance information.

In some embodiments, the assistance information includes a pattern of the second reference signals. Based on the foregoing technical solution, the second communication apparatus could receive the second reference signals based on the pattern of the second reference signals indicated by the first communication apparatus. This embodiment could refer to any relevant part of the application above, and for brevity, details are not described herein again.

The above description does not limit whether the first communication apparatus is a base station or a UE, and the following is described in combination with an example in which the first communication apparatus is a base station or the first communication apparatus is a UE.

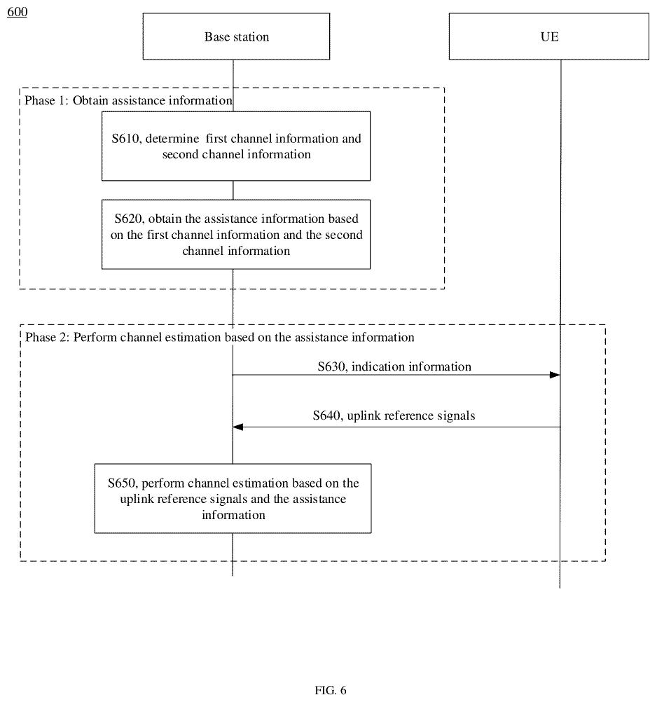

Referring to FIG. 6, a schematic interaction diagram of a communication method 600 applicable to an embodiment of this application is shown. In the method 600, the first communication apparatus is a base station, in other words, the base station obtains assistance information, and the method 600 could be used for scenarios of uplink channel estimation.

Here are two phases in the method 600.
Phase 1: Obtain assistance information.
Phase 2: Perform channel estimation based on the assistance information.
Phase 1 and Phase 2 are described in detail below.

The Phase 1 includes S610 and S620.

At S610, the base station determines the first channel information and the second channel information.

For example, the base station transmits configuration information of uplink wideband and reference signals for training; a UE transmits the reference signals based on the configuration information; the base station receives the reference signals; and the base station determines the first channel information and the second channel information by estimating the first channel and the second channel based on the reference signals.

In some embodiments, the base station performs channel estimation in different time ranges and/or different frequency ranges to obtain the first channel information and the second channel information.

S610 may refer to S510, and for brevity, details are not described herein again.

At S620, the base station obtains the assistance information based on the first channel information and the second channel information.

The assistance information indicates a relationship between the first channel and the second channel. The assistance information could be used for channel estimation.

In some embodiments, the base station obtains the assistance information based on the first channel information and the second channel information by one or more of the following: AI, manifold, or subspace projection.

In some embodiments, the assistance information could be obtained offline and/or online.

S620 may refer to S520, and for brevity, details are not described herein again.

In cases with multiple-users (UEs), the base station could determine assistance information for each UE with their own channel information; or, the base station could determine assistance information for a group of UEs with the joint channel information.

The Phase 2 includes S630-S650.

At S630, the base station transmits indication information.

Correspondingly, the UE receives the indication information.

The indication information indicates a pattern of uplink reference signals (e.g. SRS, and DMRS). For example, the assistance information includes the pattern of the uplink reference signals, and therefore the base station transmits the indication information indicating the pattern of the uplink reference signals. In some embodiments, the pattern of the uplink reference signals indicates one or more locations of the uplink reference signals, and the one or more locations include one or more frequency domain locations. This embodiment could refer to relevant part of the application above, and for brevity, details are not described herein again.

At S640, the UE transmits the uplink reference signals.

Correspondingly, the base station receives the uplink reference signals. For example, the uplink reference signal is SRS or DMRS.

At S640, the UE could transmit the uplink reference signals based on the pattern of the uplink reference signals received at S630.

At S650, the base station performs channel estimation based on the uplink reference signals and the assistance information.

For example, the base station may perform channel estimation based on the uplink reference signals and obtains a channel matrix of the first channel, and the base station obtains a channel matrix of the whole estimated channel (i.e. instantaneous uplink full channel information, where, for example, the whole estimated channel includes the second channel) based on the channel matrix of the first channel and the assistance information. For example, the assistance information may include one or more of: a projection matrix U (that is, a channel space basis matrix), a permutation matrix P, and a matrix θ, where θ=U·P, in other words, θ is a matrix obtained by displacing (that is, line swapping) of U. And the channel matrix of the whole estimated channel could be obtained by: A(i)=U_{θ}⁻¹Ĥ, where A (i) represents the channel matrix of the whole estimated channel, Ĥ represents a channel sampling matrix (e.g. a matrix of the first channel), and upper notation “−1” represents an operation of matrix pseudoinverse.

Based on the method 600, the base station could obtain channel measurements as training data, that is the first channel information and the second channel information, then the base station could obtain the assistance information based on the training data (the first channel information and the second channel information). Then the base station could perform channel estimation based on the uplink reference signals and the assistance information.

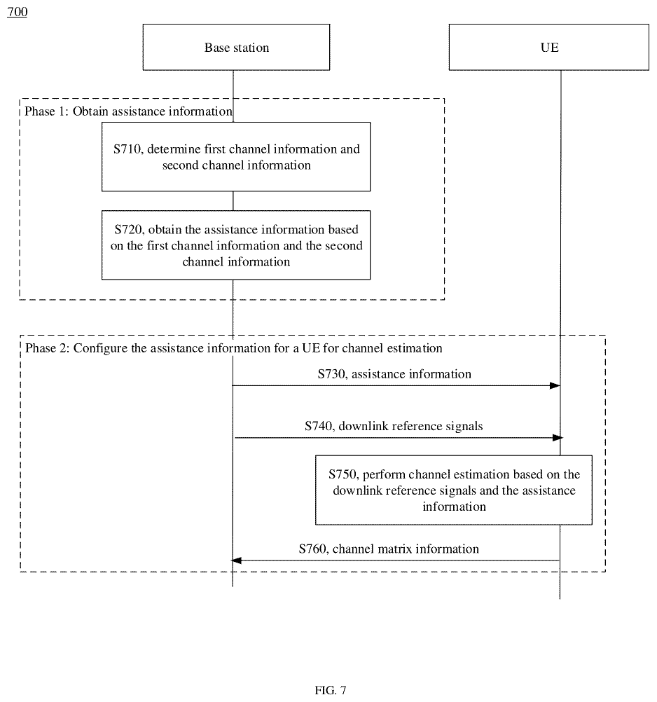

Referring to FIG. 7, a schematic interaction diagram of a communication method 700 applicable to another embodiment of this application is shown. In the method 700, the first communication apparatus is a base station, and the method 700 could be used for scenarios of downlink channel estimation.

Here are two phases in the method 700.
Phase 1: Obtain assistance information.
Phase 2: Configure the assistance information for a UE for channel estimation.
Phase 1 and Phase 2 are described in detail below.

The Phase 1 includes S710 and S720.

At S710, the base station determines first channel information and second channel information.

At S720, the base station obtains the assistance information based on the first channel information and the second channel information.

S710-S720 may refer to S610-S620, and for brevity, details are not described herein again.

The Phase 2 includes S730-S760.

At S730, the base station transmits the assistance information.

Correspondingly, the UE receives the assistance information.

The assistance information could be carried in various signaling, e.g. control signaling. For example, the assistance information could be carried in any one of: downlink control information (DCI), medium access control-control element (MAC CE), and radio resource control (RRC).

For example, the assistance information includes one or more of: a projection matrix U (that is, a channel space basis matrix), a permutation matrix P, and a matrix θ, where θ=U·P.

At S740, the base station transmits downlink reference signals.

Correspondingly, the UE receives the downlink reference signals. For example, the downlink reference signal is CSI-RS or DMRS.

At S750, the UE performs channel estimation based on the downlink reference signals and the assistance information.

For example, the UE obtains channel matrix information based on a channel estimation result. For example, channel parameters C (that is, the channel matrix information) could be obtained by: C=_{θ}⁻¹Ĥ, where the Ĥ represents channel sampling matrix (e.g. a matrix of the first channel), and upper notation “−1” represents an operation of matrix pseudoinverse. The number of rows of matrix C is r, and number of columns of C is 1. The number of rows and columns of θ is r. The number of columns of Ĥ is 1, and the number of rows of matrix H is r.

At S760, the UE transmits channel matrix information.

Correspondingly, the base station receives the channel matrix information. The base station could reconstruct downlink channel information (e.g. instantaneous downlink full channel information) based on the channel matrix information reported by the UE and the assistance information. For example, if a pivoted quartile range (QR) approach is to be used, then the base station could reconstruct downlink channel information with the following assistance information: the projection matrix U (that is, the channel space basis matrix).

Based on configuration of CSI feedback, the UE reports the channel matrix information to the base station. The CSI feedback may be designed in any one of the following manners: explicit feedback and implicit feedback.

### 1) for the Explicit Channel Feedback, Here are Two Possible Implementations.

In a possible implementation, the UE transmits channel matrix information of specific locations that is indicated by the base station. Specifically, the base station transmits indication information to the UE, and the indication information indicates the UE to report channel matrix information of the specific locations; the UE received the indication information, and in response to the indication information, the UE transmits channel matrix information of the specific locations to the base station. For example, the specific locations include: one or more pairs of Rx antenna ports and RE locations in a frequency domain.

Referring to FIG. 8, is an illustration of explicit channel feedback is shown. For example, the base station indicates the UE to report channel matrix information of the specific locations, and the specific locations include four pairs of Rx antenna ports and RE locations in a frequency domain, as shown in black blocks of FIG. 8. For brevity, (i,j) is used to indicate a pair of Rx antenna ports and RE locations in a frequency domain, where the i represents a Rx antenna port, and the j represents a RE location. The four pairs of Rx antenna ports and REs locations are: (Rx antenna port #1,RE #5), (Rx antenna port #2,RE #4), (Rx antenna port #2, RE #3), (Rx antenna port #3,RE #2), and (Rx antenna port #5,RE #1). Therefore, the UE reports channel matrix information of the specific locations indicated by the base station. As shown in FIG. 8, the UE transmits parameters which include: h₁ in first row, h₂ in second row and in third row, h3 in fourth row, and h_{R×Ant} in fifth row as shown in black blocks of FIG. 8.

In another possible implementation, the UE transmits the channel matrix information of locations, and the locations include a group of Rx antenna ports or all the Rx antenna ports in each Tx antenna port of downlink reference signals.

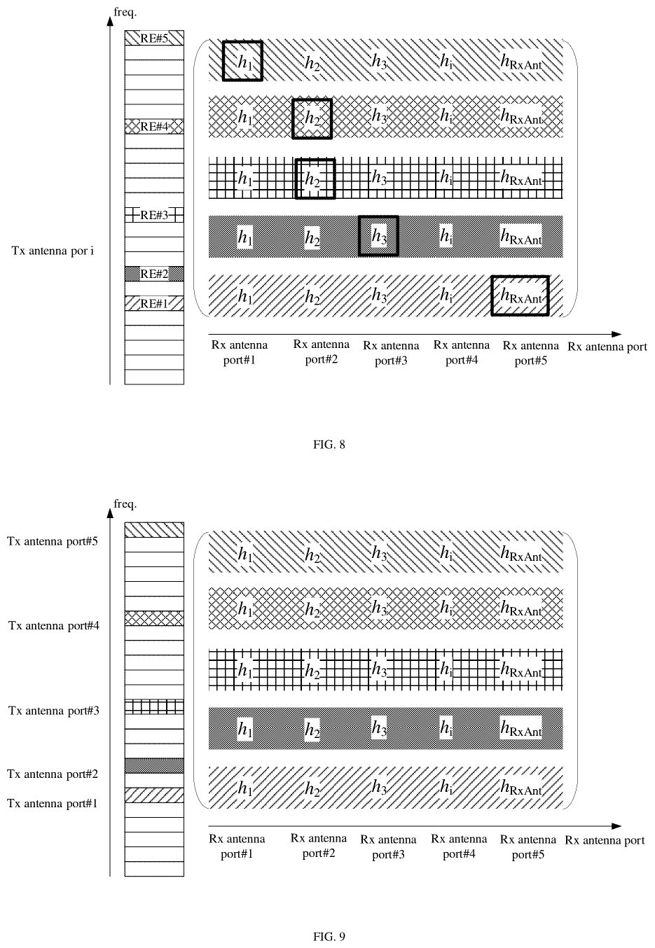

Referring to FIG. 9, another illustration of explicit channel feedback is shown. As shown in FIG. 9, the base station transmits the downlink reference signals in Tx antenna port #1, Tx antenna port #2, Tx antenna port #3, Tx antenna port #4, Tx antenna port #5), and the UE receives the downlink reference signals. The UE could report channel matrix information of locations to the base station, and the locations include a group of Rx antenna ports or all the Rx antenna ports. For brevity, (i,z) is used to indicate Rx antenna port and Tx antenna port, where the i represents a Rx antenna port, and the z represents a Tx antenna port. As shown in FIG. 9, the UE reports channel matrix information of five locations, the five locations include: (Rx antenna port #1, Tx antenna port #1), (Rx antenna port #2, Tx antenna port #2), (Rx antenna port #3, Tx antenna port #3), (Rx antenna port #4, Tx antenna port #4), and (Rx antenna port #5, Tx antenna port #5).

Based on the method 700, the base station could obtain channel measurements as training data, that is, the first channel information and the second channel information, and then the base station could obtain the assistance information based on the training data (the first channel information and the second channel information). Then the base station could transmit the assistance information to the UE for channel estimation. The UE transmits channel matrix information based on a channel estimation result, and the base station could reconstruct downlink channel information (e.g. instantaneous DL full channel information) based on the channel matrix information reported by the UE.

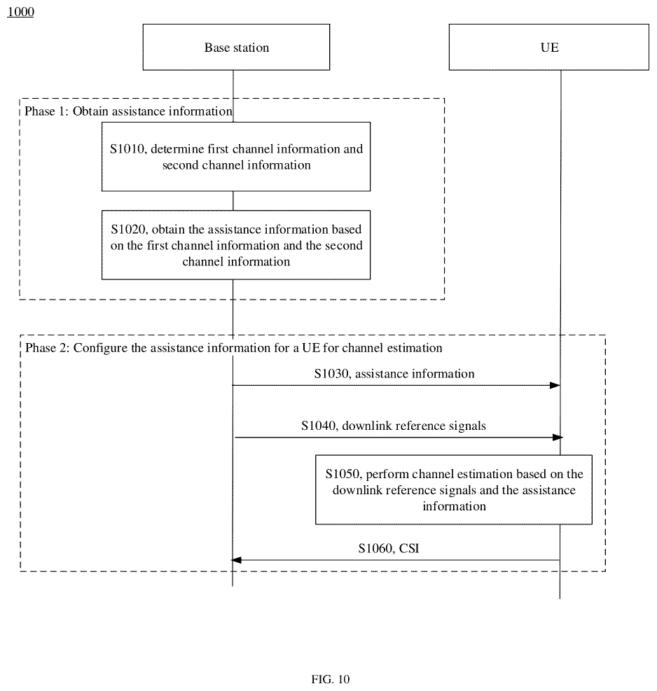

Referring to FIG. 10, a schematic interaction diagram of a communication method 1000 applicable to another embodiment of this application is shown. In the method 1000, the first communication apparatus is a base station, in other words, the base station obtains assistance information, and the method 1000 could be used for scenarios of downlink channel estimation.

Here are two phases in the method 1000.
Phase 1: Obtain assistance information.
Phase 2: Configure the assistance information for a UE for channel estimation.
Phase 1 and Phase 2 are described in detail below.

The Phase 1 includes S1010 and S1020.

At S1010, the base station determines first channel information and second channel information.

At S1020, the base station obtains the assistance information based on the first channel information and the second channel information.

S1010-S1020 may refer to S610-S620, and for brevity, details are not described herein again.

The Phase 2 includes S1030-S1060.

At S1030, the base station transmits the assistance information.

Correspondingly, the UE receives the assistance information.

The assistance information could be carried in various signaling, e.g. control signaling. For example, the assistance information could be carried in any one of: DCI, MAC CE, and RRC.

For example, the assistance information includes one or more of: a projection matrix U (that is, a channel space basis matrix), a permutation matrix P, and a matrix θ, where θ=U·P.

At S1040, the base station transmits downlink reference signals.

Correspondingly, the UE receives the downlink reference signals. For example, the downlink reference signal is CSI-RS or DMRS.

At S1050, the UE performs channel estimation based on the downlink reference signals and the assistance information.

For example, the base station may perform channel estimation based on the downlink reference signals and obtain a channel matrix of the first channel, and the base station may obtain a channel matrix of the whole estimated channel (i.e. instantaneous downlink full channel information, where, for example, the whole estimated channel includes the second channel) based on the channel matrix of the first channel and the assistance information. For example, the assistance information includes one or more of: a projection matrix U (that is, a channel space basis matrix), a permutation matrix P, and a matrix θ, where θ=U·P. And the channel matrix of the whole estimated channel could be obtained by: A(i)=U_{θ}⁻¹Ĥ, where A(i) represents the channel matrix of the whole estimated channel, Ĥ represents a channel sampling matrix (e.g. a matrix of the first channel), and upper notation “−1” represents an operation of matrix pseudoinverse.

At S1060, the UE transmits CSI.

Correspondingly, the base station receives the CSI.

For example, the CSI may include one or more of: CQI, PMI, and LI.

Based on the method 1000, the base station could obtain channel measurements as training data, that is, the first channel information and the second channel information, then the base station could obtain the assistance information based on the training data (the first channel information and the second channel information). Then the base station could transmit the assistance information to the UE for channel estimation. The UE transmit the CSI based on a channel estimation result, and the base station could obtain downlink channel information based on the CSI reported by the UE.

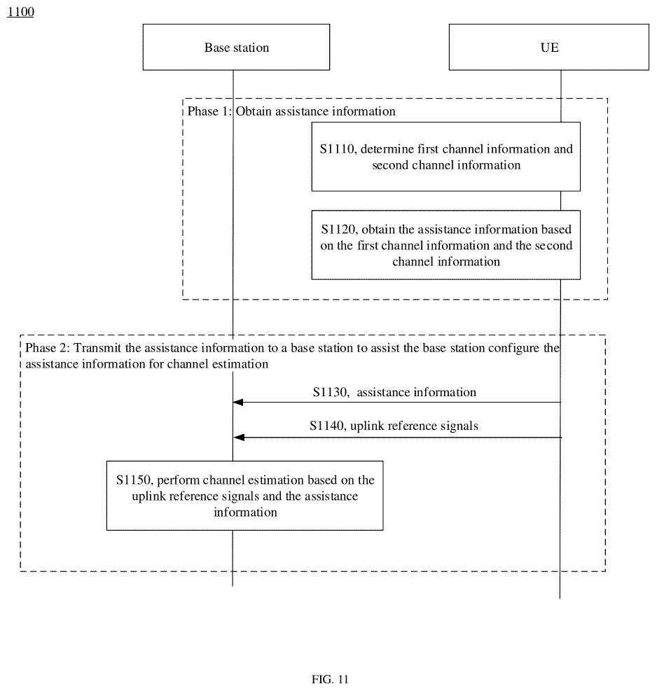

Referring to FIG. 11, a schematic interaction diagram of a communication method 1100 applicable to another embodiment of this application is shown. In the method 1100, the first communication apparatus is a UE, in other words, the UE obtains assistance information, and the method 1100 could be used for scenarios of uplink channel estimation.

Here are two phases in the method 1100.
Phase 1: Obtain assistance information.
Phase 2: Transmit the assistance information to a base station to assist the base station configure the assistance information for channel estimation.

Phase 1 and Phase 2 are described in detail below.

The Phase 1 includes S1110 and S1120.

At S1110, the UE determines first channel information and second channel information.

For example, a base station transmits reference signals (e.g. the reference signals could be referred to as training reference signals) to the UE, and the UE obtains sufficient amount of channel measurements (in high-dimensional tensor) as a training data set. Specifically, the UE performs channel estimation based on the training reference signals, and determines the first channel information and the second channel information.

In some embodiments, the UE performs channel estimation in different time ranges and/or different frequency ranges to obtain the first channel information and the second channel information.

S1110 may refer to S510, and for brevity, details are not described herein again.

At S1120, the UE obtains the assistance information based on the first channel information and the second channel information.

The assistance information indicates a relationship between the first channel and the second channel.

In some embodiments, the UE obtains the assistance information based on the first channel information and the second channel information by one or more of the following: AI, manifold, or subspace projection.

In some embodiments, the assistance information could be obtained offline and/or online.

S1120 may refer to S520, and for brevity, details are not described herein again.

The Phase 2 includes S1130-S1150.

At S1130, the UE transmits the assistance information.

Correspondingly, the base station receives the assistance information.

The assistance information could be carried in various signaling, e.g. control signaling. For example, the assistance information could be carried in any one of: uplink control information (UCI), MAC CE, and RRC.

The assistance information is used for channel estimation. For example, the assistance information includes one or more of: a projection matrix U (that is, a channel space basis matrix), a permutation matrix P, and a matrix θ, where θ=U·P.

At S1140, the UE transmits uplink reference signals.

Correspondingly, the base station receives the uplink reference signals. For example, the uplink reference signal is SRS or DMRS.

At S1150, the base station performs channel estimation based on the uplink reference signals and the assistance information.

S1150 may refer to S650, and for brevity, details are not described herein again.

Based on the method 1100, the UE could obtain channel measurements as training data, that is the first channel information and the second channel information, then the UE could obtain the assistance information based on the training data (the first channel information and the second channel information). Then the UE could transmit the assistance information to the base station for channel estimation.

Referring to FIG. 12, a schematic interaction diagram of a communication method 1200 applicable to another embodiment of this application is shown. In the method 1200, the first communication apparatus is a UE, in other words, the UE obtains assistance information, and the method 1200 could be used for scenarios of downlink channel estimation.

Here are two phases in the method 1200.
Phase 1: Obtain assistance information.
Phase 2: Perform channel estimation based on the assistance information.

At S1210, the UE determines first channel information and second channel information.

At S1220, the UE obtains the assistance information based on the first channel information and the second channel information.

S1210-S1220 may refer to S1110-S1120, and for brevity, details are not described herein again.

The Phase 2 includes S1230-S1260.

At S1230, the UE transmits indication information.

Correspondingly, the base station receives the indication information.

The indication information indicates a pattern of downlink reference signals (e.g. CSI-RS, and DMRS). For example, the assistance information includes the pattern of the downlink reference signals, and therefore the UE transmits the indication information indicating the pattern of the downlink reference signals. In some embodiments, the pattern of the downlink reference signals indicates one or more locations of the downlink reference signals, and the one or more locations include one or more frequency domain locations. This embodiment could refer to relevant part of the application above, and for brevity, details are not described herein again.

At S1240, the base station transmits the downlink reference signals.

Correspondingly, the UE receives the downlink reference signals. For example, the downlink reference signal is CSI-RS or DMRS.

In the S1240, the base station could transmit the downlink reference signals based on the pattern of the downlink reference signals received in the S1230.

At S1250, the UE performs channel estimation based on the downlink reference signals and the assistance information.

At S1260, the UE transmits CSI.

Correspondingly, the base station receives the CSI.

S1250-S1260 may refer to S1050-S1060, and for brevity, details are not described herein again.

Based on the method 1200, the UE could obtain channel measurements as training data, that is the first channel information and the second channel information, then the UE could obtain the assistance information based on the training data (the first channel information and the second channel information). Then the UE could perform channel estimation based on the downlink reference signals and the assistance information.

In this application, the “first channel estimation” is only named for differentiation and does not limit the scope of protection of the embodiments of this application. Similarly, “second channel estimation” in the application is also only named for differentiation and does not limit the scope of protection of the embodiments of this application.

In the embodiments of this application, “and/or” describes an association relationship between associated objects and represents that three relationships may exist. For example, A and/or B may represent the following three cases: only A exists, both A and B exist, and only B exists. The character “/” generally indicates an “or” relationship between the associated objects. “At least one” means one or more. “At least one of A and B”, similar to “A and/or B”, describes an association relationship between associated objects and represents that three relationships may exist. For example, at least one of A and B may represent the following three cases: only A exists, both A and B exist, and only B exists.

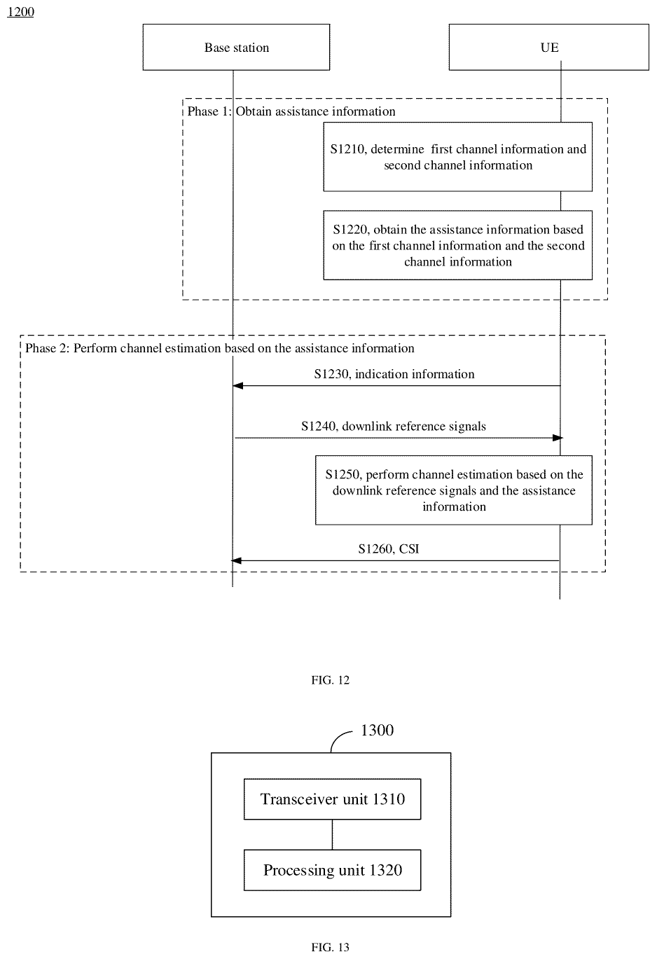

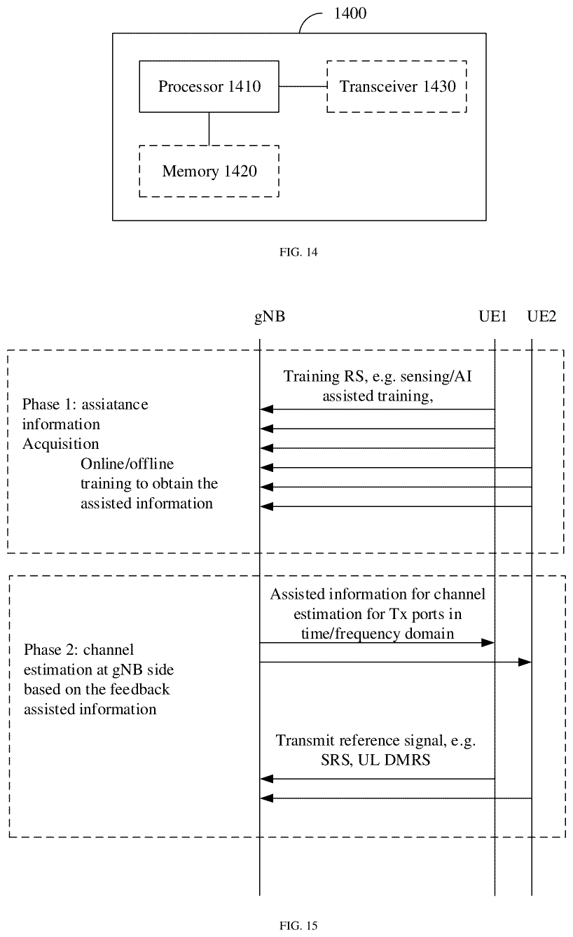

The methods according to embodiments of this application are described above in detail with reference to FIGS. 5-12. The apparatuses provided in embodiments of this application are described below in detail with reference to FIGS. 13-14. It should be understood that description of apparatus embodiments corresponds to the description of the method embodiments. Therefore, for content that is not described in detail, refer to the foregoing method embodiments. For brevity, details are not described herein again.

The communication method according to the embodiments of this application is described in detail above with reference to FIGS. 5-12, and the transmitter and the receiver according to the embodiments of this application will be described in detail below with reference to FIGS. 13-14.

Referring to FIG. 13, a schematic block diagram of a communication apparatus according to an embodiment of this application is shown. The communication apparatus 1300 includes a transceiver unit 1310 and a processing unit 1320. The transceiver unit 1310 may implement a corresponding communication function, and the processing unit 1310 is configured to perform data processing. The transceiver unit 1310 may also be referred to as a communication interface or a communication unit.

In some embodiments, the communication apparatus 1300 may further include a storage unit. The storage unit may be configured to store instructions and/or data. The processing unit 1320 may read instructions and/or data in the storage unit, to enable the communication apparatus to implement the foregoing method embodiments.

The communication apparatus 1300 may be configured to perform actions performed by the first communication apparatus in the foregoing method embodiments. In this case, the communication apparatus 1300 may be the first communication apparatus or a component that can be configured in the first communication apparatus. The transceiver unit 1310 is configured to perform receiving/transmitting-related operations on the first communication apparatus side in the foregoing method embodiments. The processing unit 1320 is configured to perform processing-related operations on the first communication apparatus side in the foregoing method embodiments.

Alternatively, the communication apparatus 1300 may be configured to perform actions performed by the second communication apparatus in the foregoing method embodiments. In this case, the communication apparatus 1300 may be the second communication apparatus or a component that can be configured in the second communication apparatus. The transceiver unit 1310 is configured to perform receiving/transmitting-related operations on the second communication apparatus side in the foregoing method embodiments. The processing unit 1320 is configured to perform processing-related operations on the second communication apparatus side in the foregoing method embodiments.

In a design, the communication apparatus 1300 is configured to perform actions performed by the first communication apparatus in the foregoing method embodiments.

In an implementation, the processing unit 1320 is configured to perform a first channel estimation to obtain first channel information of a first channel and second channel information of a second channel; and the processing unit 1320 is configured to obtain assistance information based on the first channel information and the second channel information, where the assistance information indicates a relationship between the first channel and the second channel.

The communication apparatus 1300 may implement steps or procedures performed by the first communication apparatus in FIG. 5 or the base station in FIGS. 6-10, or the UE in FIGS. 11-12 according to embodiments of this application. The communication apparatus 1300 may include units configured to perform the method performed by the first communication apparatus in FIG. 5 or the base station in FIGS. 6-10, or the UE in FIGS. 11-12. In addition, the units in the communication apparatus 1300 and the foregoing other operations and/or functions are separately used to implement corresponding procedures in FIGS. 5-12.

In another design, the communication apparatus 1300 is configured to perform actions performed by the second communication apparatus in the foregoing method embodiments.

The communication apparatus 1300 may implement steps or procedures performed by the second communication apparatus in FIG. 5 or the UE in FIGS. 6-10, or the base station in FIGS. 11-12 according to embodiments of this application. The communication apparatus 1300 may include units configured to perform the method performed by the second communication apparatus in FIG. 5 or the UE in FIGS. 6-10, or the base station in FIGS. 11-12. In addition, the units in the communication apparatus 1300 and the foregoing other operations and/or functions are separately used to implement corresponding procedures in FIGS. 5-12.

A specific process in which the units perform the foregoing corresponding steps is described in detail in the foregoing method embodiments. For brevity, details are not described herein again.

Referring to FIG. 14, a schematic block diagram of another communication apparatus according to an embodiment of this application is shown. The communication apparatus 1400 includes a processor 1410. The processor 1410 is coupled to a memory 1420. The memory 1420 is configured to store a computer program or instructions and/or data. The processor 1410 is configured to execute the computer program or instructions and/or data stored in the memory 1420, so that the methods in the foregoing method embodiments are executed.

In some embodiments, the communication apparatus 1400 includes one or more processors 1410.

In an example, as shown in FIG. 14, the communication apparatus 1400 may further include the memory 1420.

In some embodiments, the communication apparatus 1400 may include one or more memories 1420.

In an example, the memory 1420 may be integrated with the processor 1410, or disposed separately from the processor 1410.

In an example, as shown in FIG. 14, the communication apparatus 1400 may further include a transceiver 1430, where the transceiver 1430 is configured to receive and/or transmit a signal. For example, the processor 1410 may be configured to control the transceiver 1430 to receive and/or transmit a signal.

In a solution, the communication apparatus 1400 is configured to perform the operations performed by the first communication apparatus in the foregoing method embodiments.

For example, the processor 1410 may be configured to perform a processing-related operation performed by the first communication apparatus in the foregoing method embodiments, and the transceiver 1430 may be configured to perform a receiving/transmitting-related operation performed by the first communication apparatus in the foregoing method embodiments.

In another solution, the communication apparatus 1400 is configured to perform the operations performed by the second communication apparatus in the foregoing method embodiments.

For example, the processor 1410 may be configured to perform a processing-related operation performed by the second communication apparatus in the foregoing method embodiments, and the transceiver 1430 may be configured to perform a receiving/transmitting-related operation performed by the second communication apparatus in the foregoing method embodiments.

An embodiment of this application further provides a computer-readable storage medium. The computer-readable storage medium stores computer instructions used to implement the method performed by the first communication apparatus or the method performed by the second communication apparatus in the foregoing method embodiments.

For example, when the computer program is executed by a computer, the computer may be enabled to implement the method performed by the first communication apparatus or the method performed by the second communication apparatus in the foregoing method embodiments.

An embodiment of this application further provides a computer program product including instructions. When the instructions are executed by a computer, the computer is enabled to implement the method performed by the first communication apparatus or the method performed by the second communication apparatus in the foregoing method embodiments.

An embodiment of this application further provides a communication system. The communication system includes the first communication apparatus and the second communication apparatus in the foregoing embodiments.

For explanations and beneficial effects of related content of any communication apparatus provided above, refer to a corresponding method embodiment provided above. Details are not described herein again.

The processor mentioned in embodiments of this application may be a central processing unit (CPU). The processor may further be another general-purpose processor, a digital signal processor (DSP), an application-specific integrated circuit (ASIC), a field programmable gate array (FPGA), or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms such as the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In addition, function units in embodiments of this application may be integrated into one unit, or each of the units may exist alone physically, or two or more units may be integrated into one unit.

All or some of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

### A Method and Apparatus of Pairing Multiple Users in a Very Large MIMO System

The present application relates to wireless communication in a wireless network.

### Definitions of acronyms/Abbreviation/Initialism

| Full Name | Acronym/Abbreviation/Initialism |
|---|---|
| MIMO | Multiple-In Multiple-Out |
| T-MIMO | Terabit Multiple-In and Multiple-Out |
| NR | New Radio |
| gNB | Next generation base station |
| BS | Base Station |
| UE | User Equipment |
| Tx | Transmitter |
| Rx | Receiver |
| SU | Single User |
| MU | Multiple User |
| RE | Resource Element |
| SVD | Singular Vector Decomposition |
| SNR | Signal-to-Noise Ratio |
| DL | Downlink |
| UL | Uplink |
| TDD | Time Division Duplex |
| FDD | Frequency Division Duplex |
| SRS | Sounding Reference Signal |
| TTI | Time Transmission Interval |
| RF | Radio Frequency |
| IF | Intermediate Frequency |
| MAI | Multiple Access Interference |
| CSI-RS | Channel State Information Reference Signal |
| PMI | Precoding Matrix Index |
| RI | Rank Indicator |
| Pivot-QRD | Pivot QR Decomposition |
| EZF | Eigen-Zero Forcing |
| MSE | Mean Square Error |
| LOS | Line of Sight |
| NLOS | Non Light of Sight |
| RT | Ray Tracing |

### MIMO and MU-MIMO

MIMO system has been widely deployed in modern wireless systems to improve system capacity and bandwidth efficiency by making use of space diversities among antenna ports. For example, on a given subcarrier or RE, a transceiver made of N_{Tx} Tx antenna ports and NRx Rx antenna ports consists into a N_{Tx}-by-N_{Rx} MIMO channel represented by a N_{Tx}-by-N_{Rx} complex matrix H_{UE,RE}. The N_{Tx}-by-N_{Rx} MIMO channel can be decomposed via SVD H_{UE,RE}=Z_{UE RE}S_{UE,RE}V_{UE,RE}^{H}, where Z_{UE,RE} is a N_{Tx}-by-N_{Tx} square orthonormal matrix (s. t. Z_{UE,RE}^{H}Z_{UE,RE}=I), V_{UE,RE} is a N_{Rx}-by-N_{Rx} square orthonormal matrix (s.t. V_{UE,RE}^{H}V_{UE,RE}=1), and S_{UE,RE} is a N_{Tx}-by-N_{Rx} rectangular diagonal matrix. The rank of H_{UE,RE} is no more than the smaller one between N_{Rx} and N_{Tx}, i.e. T_{UE,RE}=min (N_{Tx}, N_{Rx}). Per SVD, if the transmitter applied a precoder matrix Z_{UE,RE}^{H} and the receiver a receiving matrix V_{UE,RE}, the N_{Tx}-by-N_{Rx} MIMO channel would become r_{UE,RE} independent and parallel (orthogonal) subchannels as following:

$${Z}_{UE , RE}^{H} {H}_{UE , RE} {V}_{UE , RE} = ( {Z}_{UE , RE}^{H} {Z}_{UE , RE} ) {S}_{UE , RE} ( {V}_{UE , RE}^{H} {V}_{UE , RE} ) = {S}_{UE , RE}$$

Each sub-channel has a scale value channel response (H_{UE,RE}(i)), i.e. i-th diagonal element of S_{UE,RE} (singular value, H_{UE,RE}(i)=S_{UE,RE}(i, i)). Accordingly, SNR on the i-th sub-channel is defined as

$$\frac{{‖ {H}_{UE , RE} ( i ) ‖}^{2}}{N} , i = 1 , 2 , … , {r}_{UE , RE} .$$

In a wireless system, only the sub-channels whose SNRs are higher than a threshold can be considered as effective sub-channels for transmissions. The remaining (or survival) effective sub-channels are called MIMO flows.

This SNR-based truncation scheme turns a standard SVD into a rank-reduced SVD one by discarding those sub-channels whose SNRs are lower than the threshold(s): H_{UE,RE}≈Z_{UE,RE}S_{UE,RE}V_{UE,RE}^{H} (reduced SVD), where Z_{UE,RE} is a N_{Tx}-by-T_{UE,RE} orthonormal matrix (Z_{UE,RE}^{H}Z_{UE,RE}=I), V_{UE,RE} is r_{UE,RE}-by-N_{Rx} orthonormal matrix (V_{UE,RE}^{H}V_{UE,RE}=I), and S_{UE,RE} is r_{UE,RE}-by-r_{UE,RE} square diagonal matrix. The number of MIMO flows of HUE,RE is r_{UE,RE}≤min(N_{Tx}, N_{Rx}). When the transmitter applied a precoder matrix Z_{UE,RE}^{H} and correspondent receiver applied a receiving matrix V_{UE,RE}, the N_{Tx}-by-N_{Rx} MIMO channel would become:

$${Z}_{UE , RE}^{H} {H}_{UE , RE} {V}_{UE , RE} = ( {Z}_{UE , RE}^{H} {Z}_{UE , RE} ) {S}_{UE , RE} ( {V}_{UE , RE}^{H} {V}_{UE , RE} ) = {S}_{UE , RE}$$

This time S_{UE,RE} is a r_{UE,RE}-by-r_{UE,RE} diagonal matrix.

Mathematically speaking, precoder matrix Z_{UE,RE}^{H} at the transmitter and receiving matrix V_{UE,RE} at the receiver synergy the entire MIMO channel on these remaining sub-channels by linear transformations over the MIMO channel H_{UE,RE}. Its MIMO gain or space diversity gain, indicated by the resultant SNRs

$$\frac{{‖ {H}_{UE , RE} ( i ) ‖}^{2}}{N} , i = 1 , 2 , … , {r}_{UE , RE} ,$$

is attributed to inherent space diversity of MIMO channel between transmitter and receiver, which is related to radio environment. Empirically, radio channels in such complex environment as downtown area would tend to have higher number of MIMO flows than in simpler environment, for high buildings entails more space diversity by more reflectivity.

For higher MIMO gain, wireless systems increases the number of antenna ports, that is, N_{Tx} and N_{Rx}, which hoists the upper-bound of the number of MIMO flows, because of r_{UE,RE}≤min (N_{Tx}, N_{Rx}). But, in reality, r_{UE,RE} is much smaller than its upper-bound, min(N_{Tx}, N_{Rx}). In this context, MU-MIMO was proposed: more than one MIMO channels would be multiplexed by a common precoder W. Imagine that two MIMO channels, H_{UE(1),RE} and H_{UE(2),RE}, on the same RE, are very different from each other; then it is likely to find a common precoder to multiplex both; whereas imagine that two MIMO channels, H_{UE(1),RE} and H_{UE(2),RE}, on the same RE, are almost the same; then it is unlikely to find a common precoder to multiplex both.

Mathematically, this common precoder W is related to precoders Z_{UE(1),RE} and Z_{UE(2),RE}. Concatenate both into one by z=[Z_{UE(1),RE} Z_{UE(2),RE}] where z is a N_{Tx}-by-(r_{UE(1),RE}+r_{UE(2),RE}) matrix. Their common precoder is W= [symbol] ( [symbol] ^{H} [symbol] )⁻¹ where W is a N_{Tx}-by-(T_{UE(1),RE}+T_{UE(2),RE}) matrix. If Z_{UE(1),RE} and Z_{UE(2),RE} are orthogonal, [symbol] ^{H} [symbol] approaches an identity matrix, W= [symbol] =[Z_{UE(1),RE} Z_{UE(2),RE}], meaning that the transmitter can continue using precoder matrix Z_{UE(1),RE} for UE-1 and precoder matrix Z_{UE(2),RE} for UE-2 to multiplex on this RE on the same time without MAI. If Z_{UE(1),RE} and Z_{UE(2),RE} are the same, [symbol] ^{H} [symbol] approaches a singular matrix (irreversible) so that no common precoder W is available. These two UEs cannot be paired together. Most practical cases are within the two extreme examples. [symbol] ^{H} [symbol] is neither an identity matrix nor a singular matrix. Transmitter has to compute the common precoders for all the possible combinations and then find the best one. Unfortunately, it is a NP-hard problem. Suppose that a transmitter has 200 candidate receivers. In theory, this transmitter has to make an exhaustive search among

$${\sum }_{i = 2}^{200} ( \begin{matrix}i \\ 200\end{matrix} )$$

times different common precoder W computation for different combinations of receivers. Besides, in order to increase the extent to which [symbol] ^{H} [symbol] approaches an identity matrix and pair more receivers, we usually makes N_{Tx}>>Σᵢr_{UE(i),RE}, motivating wireless systems to adopt more antenna ports or more precisely higher MIMO antenna port ratio between transmitter and receiver (N_{Tx}/N_{Rx}).

After the common precoder W is computed, the transmitter would multiply it to its transmitted signals.

### MU-MIMO Engineering Tradeoffs

For a wireless system, MU-MIMO is usually used in DL in which BS is transmitter and UEs are receivers. MIMO channels of multiple UEs are paired by a common precoder W to multiplex on the same REs (frequency) and the same time durations (timing).

To meet high throughput and system efficiency's end, modern MU-MIMO system has lots of antenna ports across a wide band. For example, in a T-MIMO system (of 6G), it is expected that BS has 1024 antenna ports and UE has 32 antenna ports over 500 MHz bandwidth. The MIMO channel of a UE becomes a three-dimensional tensor (N_{RE}-by-N_{Tx}-by-N_{Rx}).

Major tradeoff-1: Assumption on DL/UL Channel Reciprocity

Although MU-MIMO pairing is achieved over the DL channels between one BS and multiple UEs, it is impracticable for each associated UE to report or feedback its DL channel estimation to the BS, because it would result into a huge UL feedback overhead due to the large dimensionality of T-MIMO channel. In TDD system, it is assumed that the DL channel between one BS and one UE can be approximated by the UL channel between the BS and the UE. In 4G and 5G-NR systems, SRS UL channel is specified for the UL channel measurement or estimation for this purpose. SRS UL channel is shared by a number of UEs. These UEs send their own SRS reference signals on the SRS pilot positions so that the BS can estimate their UL MIMO channels respectively. In 5G-NR, the sharing is achieved by coding multiplexing on modulation signals.

Major tradeoff-2: Random or Quasi-Random MU-Pairing Implementation

As aforementioned, MU-Pairing is a NP-hard problem. In theory, the optimal pairing is a result from an exhaustive search (computation) on all the possible combinations of the candidate UEs, from 2 of them up to all of them. However, the computation that involves a pseudo-inversion of matrix [symbol] is too long for a real-time signal processing during one TTI or several TTIs. In particular, when N_{Tx} is more than hundreds or even thousands and pairing 10 or 20 UEs, the pseudo-inversion of matrix [symbol] could become computation-wisely forbidden for most hardware implementation in several TTIs. Due to the complexity and latency limitations, there is nearly no exhaustive computation to search the best pairing scheme in a practical implementation. Instead, some random or quasi-random selection of a given number of the paired UEs from a big pool of candidates is firstly conducted into z and then followed by a common precoder matrix computation W= [symbol] ( [symbol] ^{H} [symbol] )⁻¹. Empirically, the selection may consider the positions of the candidate UEs. For example, an empirical selection algorithm may tend to choose the paired UEs far from each other, because it is more likely for these UEs to have orthogonal MIMO channels. For example, the number of the paired is simply given by empirical experience or hardware limitation.

Strictly speaking, the tradeoff doesn't realize the pairing but only compute the precoder matrix W from whichever reversible [symbol] ^{H} [symbol] .

### Assistance Information of LTE and 5G-NR RS

3GPP has introduced Quasi-Colocation (QCL) concept in LTE and 5G-NR to help the UE with channel estimation, frequency offset error estimation and synchronization procedures. For example, if UE knows that the radio channels corresponding to two different antenna ports is QCL in terms of Doppler shift, then UE can determine Doppler shift for one antenna port and then apply the result on both antenna ports for channel estimation. This avoids the UE to calculate doppler for both antenna port separately.

The antenna port can be used for transmission of a physical channel or signal. The antenna port can be defined so that the channel over which a symbol on the antenna port is conveyed can be inferred from the channel over which another symbol on the same antenna port is conveyed. Different antenna ports can correspond to different reference signals, which can be used for channel estimation and processing of the physical channel transmitted on the same antenna ports. Antenna ports that correspond to different reference signals may be located at the same location, or different locations. Each channel of a signal from differently located antenna ports can have substantially different large scale properties due to the different location, different distance from a UE, different signal paths, and so forth. However, antenna ports that are located at different locations may still have similar large scale properties if the distance between the ports is not substantial. These antenna ports can be assumed to have the same large scale properties. They are referred to as being quasi co-located. Two antenna ports can be quasi co-located if the large-scale properties of the channel over which a symbol on one antenna port is conveyed can be inferred from the large-scale properties of the channel over which a symbol on the other antenna port is conveyed.

5G NR have support for multi-antenna transmission, beam-forming, and simultaneous transmission from multiple geographically separates sites (COMP). In such cases, the channels of different antenna ports relevant for a UE may differ even in terms of radio channel properties and QCL antenna port may be geographically separated. Therefore, QCL information actually is a type of assistance information for channel estimation, which utilize the commonality of channel properties among different antenna ports.

### Non-Uniform Pilot Placement Patterns

Both 5G-NR SRS UL Channels and CSI-RS DL channels employs uniform pilot placement patterns, partly because uniform pilot placement patterns are among the safest method to ensure channel estimation performance in particular with little prior-knowledge about the current channel, partly because they are easy to be described, standardized, and aligned (configured) across transceiver. However, uniform pilot placement patterns are one of the lowest efficient patterns. Its density must be designed for the worst case in statistics, which is rare in practice. In another word, uniform pilot placement patterns specified in the 5G-NR standard may as well be over-designed in most practical cases.

In 5G-NR, average density of its uniform pilot placement patterns is about 7%-17% of its radio resource to be used for pilots or reference signals. For example, every RB (made of 12 REs) has one reference signals, resulting into 8.33% (˜1/12) overhead for pilots. If the same uniform density were to be employed in TMIMO, the overhead would be too huge to be processed. At least, it would be impossible for these UEs on the edge to feedback huge CSIs.

In theory, non-uniform pilot placement patterns based on prior-knowledge about distribution of a channel would use much less pilot overhead. First of all, how is prior-knowledge represented and found? It is invented that the prior-knowledge about a high-dimensional signal space (MIMO channel can be considered as high-dimensional signal space) can be represented by an orthonormal basis N_{dim}-by-rₑₙᵥ U (s.t. U^{H}U=I). One column of U is one of the basis, meaning that any two columns of U are perfectly orthogonal to each other. In the IPR, we use the column as basis; it can be easily applied to that basis matrix whose rows are basis; simply U^{H}. N_{dim} is the total dimension after vectorized. For example, the total dimension of a MIMO channel of N_{RE}-by-N_{Tx}-by-N_{Rx} is N_{dim}=N_{RE}N_{Tx}N_{Rx}. rₑₙᵥ is related to how complicated the prior-knowledge contain. In mathematic, rₑₙᵥ is the number of principal components of the prior knowledge. Proposes to use data-learning method to generate the prior knowledge. The basis U is computed from a number of data samples collected or sampled in the area. further propose to apply this data-learning method in MIMO case where U is a representation of a common spatial prior-knowledge of MIMO channels within an area of interest.

From the prior knowledge represented a common spatial basis (U), a near-optimal non-uniform pilot placement pattern can be computed by pivot QRD on U:UP=QR. The several “strongest” pivots in P (in typical pivot QRD, the pivots are ordered in terms of their importance or contributiveness) would indicate the most important or contributive positions to place reference signals (or pilots) for the reconstruction purpose.

Non-uniform pilot placement pattern(s) indicated by pivots in P would result into near minimum overhead of pilots or reference signals but still minimize MSE on the reconstruction (or decoder, decompression).

The radio channel properties which may be common across the antenna ports includes Doppler spread/shift, average delay, delay spread, average gain and spatial receiver parameters. This properties are known as “large-scale properties”. A short definition of each is given below.
Doppler Shift: Doppler shift is a shift in the frequency of the radio signal relative to motion of the receiver. E.g. gNB transmits a radio signal of a frequency “X” however the receiver (UE) is in mobility traveling away from the gNB so that same radio signal due to the distance of the UE by the time it reaches the UE the frequency is changed to “Y”, this phenomenon is known as Doppler shift. A real life example is the sound of a speeding train that comes close and speeds away to person standing on the platform, is called Doppler shift of sound wave.
Doppler Spread: Doppler Spread is known as fading rate, difference between the signal frequency at the Tx & Rx with respect to time is called Doppler spread. E.g. The rate at which the train sound changes over time is called Doppler spread.
Average Delay: When signal is transmitted from multiple antenna, it reaches to receiver through multiple path reflect from surrounding clutter. In multi path scenario the average time taken to receive all the Multi path components at the receiver is known as Average Delay.
Delay Spread: Difference between the time of arrival of the earliest significant multi path component i.e. typically the line of sight (LOS) component and the time of arrival of the last multi path component is known as Delay spread.
Spatial Receiver Parameter: Spatial Receiver Parameter are refers to Beam Forming properties of Downlink received signal like dominant Angle of Arrival, average Angle of Arrival at UE.
Following table mentions 5G NR QCL Types.

| QCL type | Description |
|---|---|
| Type-A | {Doppler shift, Doppler spread, average delay, delay |
| | spread} |
| Type-B | {Doppler shift, Doppler spread} |
| Type-C | {Doppler shift, average delay} |
| Type-D | {Spatial Rx parameter} |

The large-scale properties of the channel can include one or more of: average delay, delay spread, Doppler shift, Doppler spread, and average gain. The average delay can include the first-order statistics for the time property of a channel. The delay spread can include the second-order statistics for the time property of the channel. The Doppler shift can include the first-order statistics for the frequency properties of a channel. The Doppler spread can include the second-order statistics for the frequency properties of a channel. The average gain can include the first-order statistics for the amplitude properties of the channel. The large-scale properties estimated on antenna ports of reference signals can be used to parametrize the channel estimator and compensate for possible time and frequency errors when deriving channel state information (CSI) feedback or when performing demodulation.

### Problem and Objective

Assistance Information of LTE and 5G-NR RS, e.g. QCL

The major disadvantage is that it utilize the commonality of different antenna ports only, other than the correlation among different antenna ports, which could help to improve channel estimation accuracy on top of reference signals.

This invention focuses on how to obtain assistance information for channel estimation from the prior-knowledge of channel status of the target environment. This means the system need design a procedure to acquire the assistance information, e.g. channel space basis (U) or similar channel-status-related representation of the target environment.

### Overview

A new procedure of assisted information acquisition for channel estimation for DL RS and/or UL RS, which could be
two phase, the first phase is online/offline training to acquire the assisted information at gNB side or UE side; and the second phase is to apply the assisted information to estimate channel coefficients
   For the first phase
   gNB transmits the configuration of UL wideband and even RS for training
   UE transmits UL wideband and even RS to gNB
   gNB receive and collect the channel information based on the RS and calculate the assisted information for channel estimation, which could be
      Matrix/Vector/Tensor/Manifold based information
For the second phase
   gNB configure the assisted information to UE for channel estimation.
The assisted information for channel estimation could be configured by RRC and indicated by MAC-CE/DCI to UE, which could be updated synchronously or non-synchronously with the associated reference signal

A new procedure of assisted information acquisition for channel estimation for DL RS and/or UL RS, which could be
For the first phase
   gNB transmits the configuration of DL wideband and even RS for training
   gNB transmits DL wideband and even RS to UE
   UE receive and collect the channel information based on the RS and calculate the assisted information for channel estimation, which could be
      Matrix/Vector/Tensor/Manifold based information
   UE send the assisted information to gNB side
For the second phase
   gNB configure the assisted information to UE for channel estimation

The assisted information for channel estimation could be configured by RRC and indicated by MAC-CE/DCI to UE, which could be updated synchronously or non-synchronously with the associated reference signal

The current invention can be used to solve the channel estimation problem for T-MIMO system where there is large number for transmitter and receiver antenna ports and large bandwidth. The same method can be also applied to normal MIMO system (for example, 5G MIMO system), or even single antenna system.

By using the current invention, the following characters will show up in the system:
Require assistance information for channel estimation, which is obtained from the prior-knowledge of channel status of the target environment.
The accuracy of channel estimation will be improved based on the assistance information proposed in this ideas. The assistance information for channel estimation cloud also enable a far sparse pilot pattern(s) than traditional pilot pattern(s) (5G NR pilot design) and it could be non-uniformly distributed along time-frequency-spatial resources.

### EMBODIMENTS

### 1. Embodiment 1

### 1.1 Detailed Description of Embodiment

In this embodiment, we consider the scenario that gNB acquires assisted information and configures RS. The following process shows the air interface interaction for UL pilot detection (e.g. SRS, UL DMRS). We will take SRS as the example in this embodiment. The There are two main phases in this procedure.

### Phase1: Online/Offline Training to Obtain Assisted Information.

1) In this phase, gNB side collects sufficient amount of channel measurements (in high-dimensional tensor) as training data set.
   a. For data collection, we can define the different time and frequency window for different training stage. For example, the window for offline training can be hundreds of TTI and whole frequency band for transmission while the window for online training can be several symbols and subcarriers or BWP.
   b. The channel in measurement can be the pure physical channel or precoding channel.
2) Then gNB trains the assisted information based on the training data set and configure the assisted information.
   a. The training procedure can be done in offline/online stage or both.
      i. One possible approach for joint offline and online training is that we apply offline training to obtain the initial assisted information and apply online training to update assisted information.
   b. The method for training can be AI approach, manifold approach, subspace projection or other approach and it is not restricted here.
   c. For MU case:
      i. gNB can train the assisted information for each UE with their own channel information.
      ii. gNB can train the assisted information for a group of UE with the joint channel information.

### Phase2: Configure the Assisted Information to UE to Perform Channel Estimation

1) gNB indicate the assisted information to UE.
   a. If the assisted information is RS pattern, the indicated RS pattern can be as following:
      i. RS position contains multiple pairs of Tx and REs location in frequency.
      ii. RS position contains multiple REs location in frequency, which means that all the Tx port in these frequency locations should be transmitted. iii. RS position contains multiple pairs of CDM groups and REs location in frequency.
2) UE sends sparse SRS based on the indicated information to gNB
3) gNB reconstructs instantaneous UL full channel information based on channel matrix information reported by UE with the aid of assisted information.
   i. If the pivoted QR approach is applied, then gNB can reconstruct full channel information with the following assisted information: low dimension projection matrix θ and projection matrix U.

FIG. 15 illustrates the main procedure for the embodiment 1.

### 1.2 the Technical Benefit(s)/Advantage(s) of Embodiment

This embodiment describes the procedure of channel estimation with SRS in UL scenario. Compared with current procedure of SRS whose pattern is regular with high density, the number of SRS pilots greatly reduces for the application of assisted information. One possible drawback of this approach is that the SRS pattern is irregular, which may need high cost of air-interface indication.

### 2. Embodiment 2

### 2.1 Detailed Description of Embodiment

Similar to embodiment 1, we also consider the scenario that gNB acquires assistance information and configures RS. However, this embodiment, we consider the DL pilot detection, which prefers to CSI-RS. The following process shows the channel estimation for CSI-RS with explicit feedback. There are two main phases in this procedure, but the details are different.

### Phase1: Online/Offline Training to Obtain Assisted Information.

1) In this phase, gNB side collects sufficient amount of channel measurements (in high-dimensional tensor) as training data set.
   a. For data collection, we can define the different time and frequency window for different training stage. For example, the window for offline training can be hundreds of TTI and whole frequency band for transmission while the window for online training can be several symbols and subcarriers or BWP.
   b. The channel in measurement can be the pure physical channel or precoding channel.
2) Then gNB trains the assisted information based on the training data set and configure the assisted information.
   a. The training procedure can be done in offline/online stage or both.
      i. One possible approach for joint offline and online training is that we apply offline training to obtain the initial assisted information and apply online training to update assisted information.
   b. The method for training can be AI approach, manifold approach, subspace projection or other approach and it is not restricted here.

### Phase2: Configure the Assisted Information to UE to Perform Channel Estimation

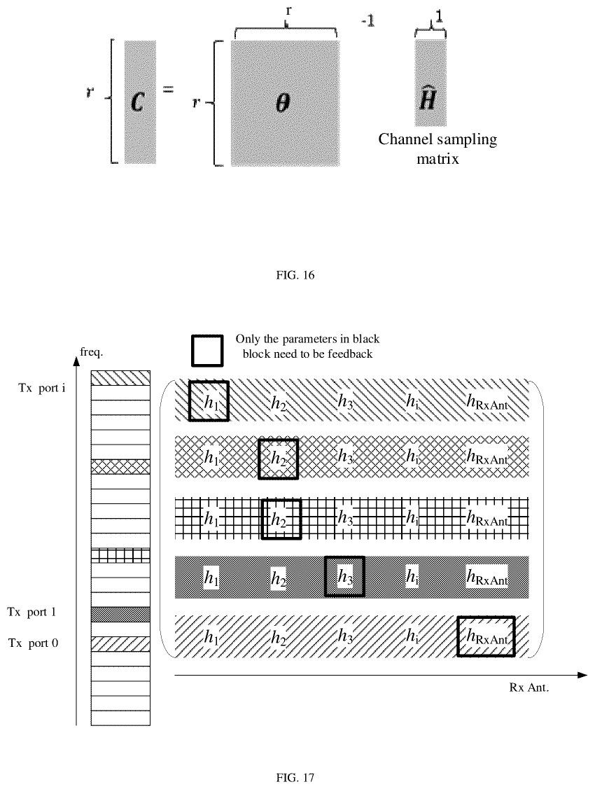

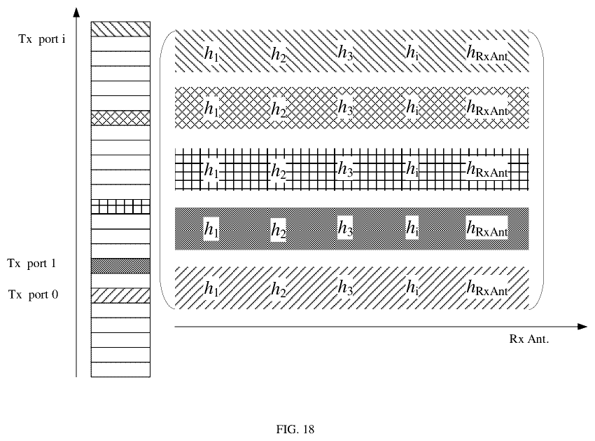

1) gNB send the assisted information to UE by control signaling, e.g. RRC/MAC CE/DCI. The assisted information can be but not restricted as follows:
   a. If apply the pivoted QR approach, we can indicate the low dimension projection θ to UE. There are two approaches for this indication:
      i. Directly indicates the low dimension projection matrix θ to UE.
      ii. Indicates the projection matrix U and permutation matrix P to UE and UE can compute the low dimension projection matrix as: θ=U*P.
2) gNB sends sparse CSI-RS to UE
3) UE conducts channel estimation based on CSI-RS and computes the channel parameters C.
   a. If the pivoted QR approach is applied, then the channel parameters C can be obtained as FIG. 16, where θ is the low dimension projection matrix and Ĥ is the channel sampling matrix. FIG. 16 is an illustration of channel parameters.
4) Based on the configuration of CSI feedback, UE reports the channel information to gNB. For the CSI feedback, we have two approaches: explicit feedback and implicit feedback and the difference is illustrated as below:
   a. For explicit channel feedback, we have two alternatives:
      i. Only the channel matrix information of pairs of Rx and REs location in frequency that indicated by gNB are expected to be feedback (E.g. the channel parameters in ith RE, jth Rx port). FIG. 17 is an illustration of feedback the channel information of indicated pairs of RX and RE location in frequency.
   ii. Feedback the channel matrix information of a group of Rx antennas or all the Rx antennas in every CSI-RS transmission port. FIG. 18 is an illustration of feedback the channel information of a group of or all RXs in RE location in frequency.
b. For implicit channel feedback, we have two alternatives as well:
   i. Only the channel parameters corresponding to channel matrix information of pairs of Rx and REs location in frequency that indicated by gNB are expected to be feedback (E.g. the channel parameters in ith RE, jth Rx port).
   ii. Feedback the channel parameters corresponding to channel matrix information of a group of Rx antennas or all the Rx antennas in every CSI-RS transmission port.
5) gNB reconstructs instantaneous DL full channel information based on channel matrix information reported by UE with the aid of assisted information.
   a. If the pivoted QR approach is applied, then gNB can reconstruct full channel information with the following assisted information: projection matrix U.

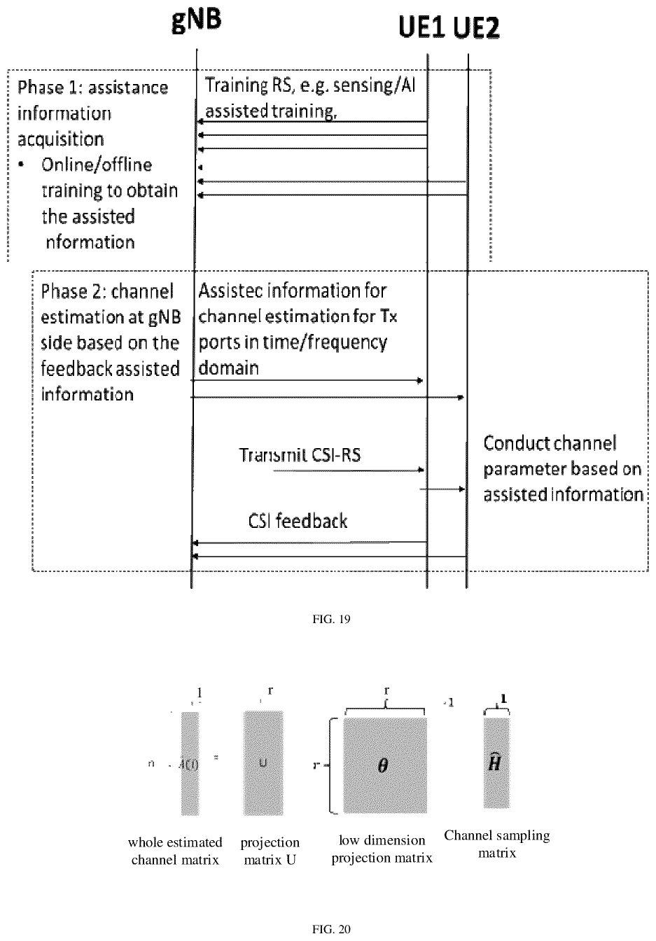

FIG. 19 illustrates the main procedure for the embodiment 2.

### 2.2 the Technical Benefit(s)/Advantage(s) of Embodiment

This embodiment describes the procedure of channel estimation with CSI-RS and explicit CSI feedback. Compared with current procedure of CSI-RS, the cost of CSI pilots dramatically decreases. UE feedbacks a small amount of channel information matrix instead of PMI, which reduces the computation complexity and feedback cost.

### 3. Embodiment 3

### 3.1 Detailed Description of Embodiment

In this embodiment, we also consider the channel estimation with CSI-RS. The difference is that we consider UE conduct channel estimation. Therefore, the procedure of CSI feedback does not change anymore. The following process shows the whole procedure of channel estimation.

### Phase1: Online/Offline Training to Obtain Assistance Information.

1) In this phase, gNB side collects sufficient amount of channel measurements (in high-dimensional tensor) as training data set.
   a. For data collection, we can define the different time and frequency window for different training stage. For example, the window for offline training can be hundreds of TTI and whole frequency band for transmission while the window for online training can be several symbols and subcarriers or BWP.
   b. The channel in measurement can be the pure physical channel or precoding channel.
2) Then gNB trains the assisted information based on the training data set and configure the assisted information.
   a. The training procedure can be done in offline/online stage or both.
      i. One possible approach for joint offline and online training is that we apply offline training to obtain the initial assisted information and apply online training to update assisted information.
   b. The method for training can be AI approach, manifold approach, subspace projection or other approach and it is not restricted here.

### Phase2: Configure the Assisted Information to UE to Perform Channel Estimation

1) gNB send the information of assisted information to UE by control signaling, e.g. RRC/MAC CE/DCI. The assisted information can be but not restricted as following:
   a. If applying the pivoted QR approach, we can indicate the following assisted information:
      i. projection matrix U
      ii. permutation matrix P
      iii. low dimension projection θ
2) gNB sends sparse CSI-RS to UE
3) UE reconstructs instantaneous DL full channel information based on CSI-RS with the aid of assisted information.
   a. If the pivoted QR approach is applied, then the instantaneous DL full channel, where Ĥ is the channel sampling matrix obtained from CSI-RS, as shown in FIG. 20.
4) Since UE obtains the whole channel matrix, the traditional CSI feedback can be applied, like feedback the PMI, CQI, RI and other parameters.

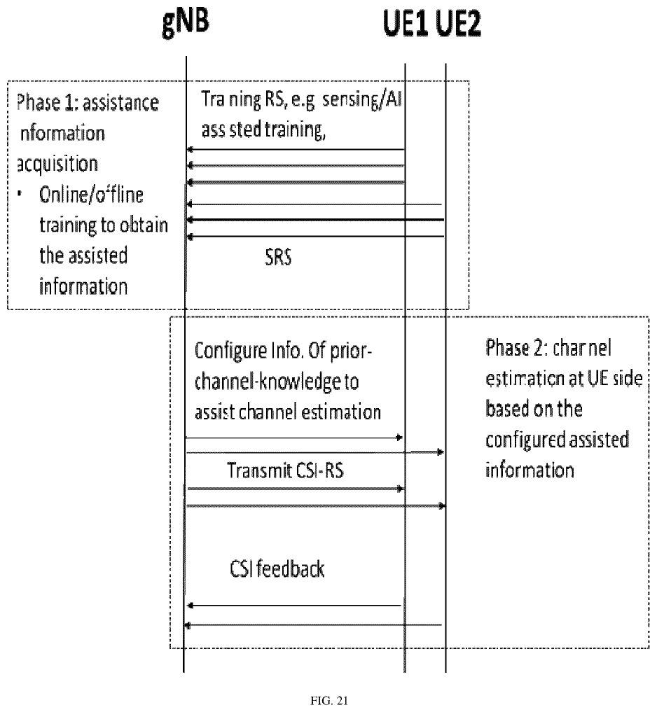

FIG. 21 illustrates the main procedure for the embodiment 3.

### 3.2 the Technical Benefit(s)/Advantage(s) of Embodiment

This embodiment describes the procedure of channel estimation with CSI-RS in UE side. Compared with previous embodiments, since UE obtains the whole channel information, the traditional CSI feedback can be applied, which is friendly to current NR standard.

### 4. Embodiment 4

### 4.1 Detailed Description of Embodiment

Different from previous embodiment, in the case, we consider that UE obtains prior channel knowledge and feedback the assisted information to gNB. Similarly, training stage and channel estimation stage compose the whole procedure. The following process illustrates the air interface interaction for UL channel estimation.

### Phase1: Online/Offline Training to Obtain Assisted Information.

1) In this phase, gNB sends training RS to UE and UE collects sufficient amount of channel measurements (in high-dimensional tensor) as training data set.
   a. The configuration of training for different UE can be the same or UE specific. For example:
      i. Training RS for each UE can be same/different time or frequency RE and Tx port.
      ii. The training window for each UE can have different time and frequency length
      iii. The training model of different UE can be different, it can be online or offline or both.
2) Then UE trains the assisted information based on the training data set. The assisted information could contain UL reference signal pattern, e.g. SRS, UL DMRS.
   a. The training procedure can be done in offline/online stage.
   b. The method for training can be AI approach, manifold approach, subspace projection or other approach and it is not restricted here.

### Phase2: Configure the Assisted Information to gNB to Perform Channel Estimation

1) UE sends the assisted information to gNB by control signaling, e.g. RRC/MAC CE/DCI. The assisted information is used for channel estimation for Tx ports in time/frequency domain. The assisted information can be but not restricted as follows:
   a. If apply the pivoted QR approach, the projection matrix U and permutation matrix P should be indicated to gNB.
2) UE transmits sparse reference signals to gNB, e.g. SRS. UL DMRS.
3) gNB reconstructs instantaneous full channel information based on channel matrix information obtained from the reference signals with the aid of assisted information reported by UE.
   a. If the pivoted QR approach is applied, then gNB can reconstruct full channel information with the following assisted information: projection matrix U and permutation matrix P.

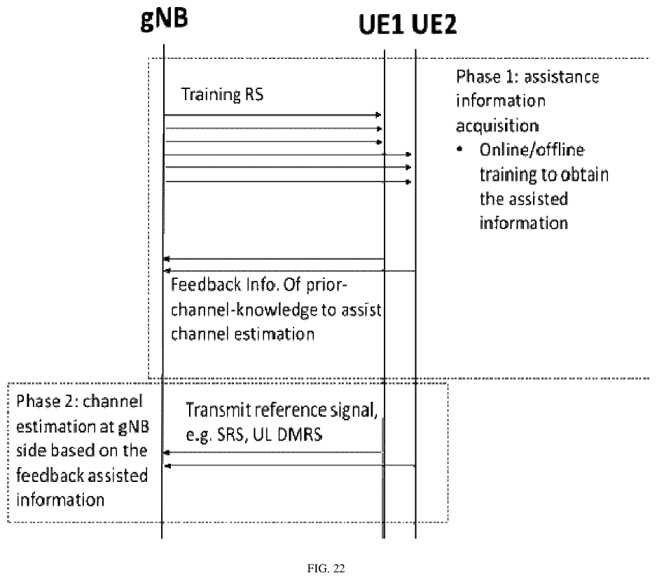

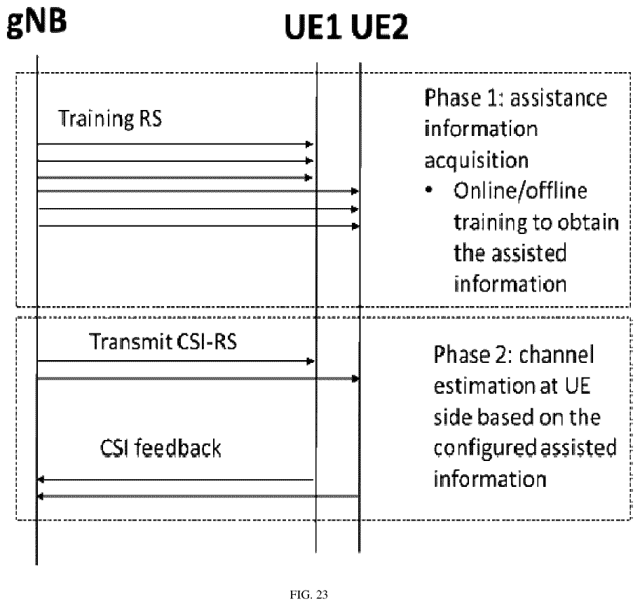

FIG. 22 illustrates the main procedure for the embodiment 4.

### 4.2 the Technical Benefit(s)/Advantage(s) of Embodiment

This embodiment describes the procedure of channel estimation with UL RS.

Different from previous embodiments, we consider UE obtains prior channel knowledge instead of gNB. Therefore, UE can update the assisted information by itself, which can reduce the computation complexity in gNB side and save the UL resource for training.

### 5. Embodiment 5

### 5.1 Detailed Description of Embodiment

Different from previous embodiment, in the case, we consider that UE obtains prior channel knowledge and feedback the assisted information to gNB. Similarly, training stage and channel estimation stage compose the whole procedure. The following process illustrates the air interface interaction for DL channel estimation.

### Phase1: Online/Offline Training to Obtain Assisted Information.

1) In this phase, gNB sends training RS to UE and UE collects sufficient amount of channel measurements (in high-dimensional tensor) as training data set.
   a. The configuration of training for different UE can be the same or UE specific. For example:
      i. Training RS for each UE can be same/different time or frequency RE and Tx port.
      ii. The training window for each UE can have different time and frequency length
      iii. The training model of different UE can be different, it can be online or offline or both.
2) Then UE trains the assisted information based on the training data set. The assisted information could contain DL reference signal pattern, e.g. CSI-RS, DMRS.
   a. The training procedure can be done in offline/online stage.
   b. The method for training can be AI approach, manifold approach, subspace projection or other approach and it is not restricted here.

### Phase2: Configure the Assisted Information to gNB to Perform Channel Estimation

1) UE sends the assisted information to gNB by control signaling, e.g. RRC/MAC CE/DCI. The assisted information is used for channel estimation for Tx ports in time/frequency domain. The assisted information can be but not restricted as follows:
   a. The pattern of DL RS, which can be the following form:
      i. The DL RS position contains multiple pairs of Tx and REs location in frequency.
      ii. The DL RS position contains multiple REs location in frequency, which means that all the Tx ports in these frequency locations should be transmitted.
      iii. The DL RS position contains multiple pairs of CDM groups and REs location in frequency.
2) gNB transmits sparse reference signals to UE, e.g. CSI-RS, DMRS.
3) UE reconstructs instantaneous DL full channel information based on DL RS with the aid of assisted information.
4) Since UE obtains the whole channel matrix, the traditional CSI feedback can be applied, like feedback the PMI, CQI, RI and other parameters.

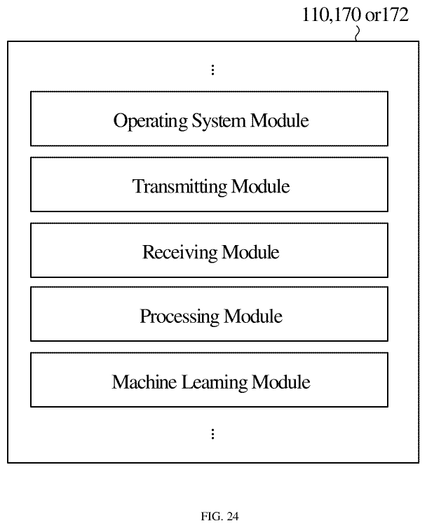

FIG. 23 illustrates the main procedure for the embodiment 5.

### 5.2 the Technical Benefit(s)/Advantage(s) of Embodiment

This embodiment describes the procedure of channel estimation with DL RS.

Different from embodiment 4, we consider UE obtains assisted information and UE conducts the whole channel estimation. The benefit is that the UE does not need to transmit the assisted information to gNB, which reduces the cost of air-interface indication.

The methods herein are performed by a device or an apparatus, e.g. by a processor of the device or apparatus executing instructions stored in a memory. The instructions, when executed, cause the device or apparatus to perform the methods.

The various options and embodiments described herein may be combined in different permutations. Also, although the invention has been described with reference to specific features and embodiments thereof, various modifications and combinations can be made thereto without departing from the invention. The description and drawings above are, accordingly, to be regarded simply as an illustration of some embodiments of the invention, and are contemplated to cover any and all modifications, variations, combinations or equivalents.

### 6G System Structure

### 6G Basic Module Structure

One or more steps of the embodiment methods provided herein may be performed by corresponding units or modules, according to FIG. 24. FIG. 24 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

What is claimed is:

1. A method, comprising:
performing a first channel estimation to obtain first channel information of a first channel and second channel information of a second channel; and
obtaining assistance information based on the first channel information and the second channel information, wherein the assistance information indicates a relationship between the first channel and the second channel.

2. The method according to claim 1, wherein performing the first channel estimation to obtain the first channel information of the first channel and the second channel information of the second channel comprises:
performing the first channel estimation in different time ranges or different frequency ranges to obtain the first channel information and the second channel information.

3. The method according to claim 1, wherein obtaining the assistance information based on the first channel information and the second channel information comprises:
obtaining the assistance information based on the first channel information and the second channel information by one or more of the following: artificial intelligence, manifold, or subspace projection.

4. The method according to claim 1, further comprising:
receiving first reference signals; and
performing a second channel estimation based on the first reference signals and the assistance information.

5. The method according to claim 4, wherein the assistance information comprises a pattern of the first reference signals, and the method further comprises:
transmitting the pattern of the first reference signals.

6. A method, comprising:
receiving reference signals; and
performing a second channel estimation based on the reference signals and assistance information, wherein the assistance information is determined based on first channel information of a first channel and second channel information of a second channel, the first channel information and the second channel information is determined by performing first channel estimation, and wherein the assistance information indicates a relationship between the first channel and the second channel.

7. The method according to claim 6, wherein the first channel information and the second channel information are determined by performing the first channel estimation in different time ranges or different frequency ranges.

8. The method according to claim 6, wherein the assistance information is determined based on the first channel information and the second channel information by using one or more of the following: artificial intelligence, manifold, or subspace projection.

9. The method according to claim 6, further comprising:
receiving the assistance information.

10. The method according to claim 6, wherein the assistance information comprises a pattern of the reference signals.

11. An apparatus, comprising:
at least one processor coupled with at least one memory storing one or more instructions that are capable of being run on the at least one processor, wherein when the one or more instructions are run, the apparatus is enabled to:
perform a first channel estimation to obtain first channel information of a first channel and second channel information of a second channel; and
obtain assistance information based on the first channel information and the second channel information, wherein the assistance information indicates a relationship between the first channel and the second channel.

12. The apparatus according to claim 11, wherein the one or more instructions to perform the first channel estimation to obtain the first channel information of the first channel and the second channel information of the second channel comprise one or more instructions to:
perform the first channel estimation in different time ranges or different frequency ranges to obtain the first channel information and the second channel information.

13. The apparatus according to claim 11, wherein one or more instructions to obtain the assistance information based on the first channel information and the second channel information comprise one or more instructions to:
obtain the assistance information based on the first channel information and the second channel information by one or more of the following: artificial intelligence, manifold, or subspace projection.

14. The apparatus according to claim 11, wherein when the one or more instructions are run, the apparatus is further enabled to:
receive first reference signals; and
perform a second channel estimation based on the first reference signals and the assistance information.

15. The apparatus according to claim 14, wherein the assistance information comprises a pattern of the first reference signals, and when the one or more instructions are run, the apparatus is further enabled to:
transmit the pattern of the first reference signals.

16. An apparatus, comprising:
at least one processor coupled with at least one memory storing one or more instructions that are capable of being run on the at least one processor, wherein when the one or more instructions are run, the apparatus is enabled to:
receive reference signals; and
perform a second channel estimation based on the reference signals and assistance information, wherein the assistance information is determined based on first channel information of a first channel and second channel information of a second channel, the first channel information and the second channel information is determined by performing first channel estimation, and wherein the assistance information indicates a relationship between the first channel and the second channel.

17. The apparatus according to claim 16, wherein the first channel information and the second channel information are determined by performing the first channel estimation in different time ranges r different frequency ranges.

18. The apparatus according to claim 16, wherein the assistance information is determined based on the first channel information and the second channel information by using one or more of the following: artificial intelligence, manifold, or subspace projection.

19. The apparatus according to claim 16, wherein when the one or more instructions are run, the apparatus is further enabled to:
receive the assistance information.

20. The apparatus according to claim 16, wherein the assistance information comprises a pattern of the reference signals.
